(19) United States
(12) Patent Application Publication
(10) Pub. No.: US 2007/0040516 A1
(43) Pub. Date: Feb. 22, 2007

(54) AC to DC power supply with PFC for lamp

(76) Inventor: Liang Chen, McKinney, TX (US)

Correspondence Address: Liang Chen, 5305 Hampshire Drive, McKinney, TX, 75070, US

(21) Appl. No.: 11/204,307

(22) Filed: Aug. 15, 2005

(51) Int. Cl. H05B 41/36

(52) U.S. Cl. 315/291

(57) ABSTRACT

An AC-to-DC converter with PFC or without PFC generates an output constant voltage at any predetermined value (no matter less or more than input line peak voltage, or even equal to input line peak voltage) with an input line AC voltage with wide range (Typical sinusoidal 110 VAC, 60 Hz or 220 VAC, 50 Hz). It is mainly used as power supply for lamp. Previous power supply for lamp has low frequency component or high frequency component. (1) Low frequency light cause eyes pupil and crystalline lens will adjust 60 times, 120 or many times per second to cause eyes tired. Pupil open wide and crystalline lens adjust to collect more light to focus on retina for seeing clearly at weak light while pupil open narrow and crystalline lens adjust to collect less light to focus on retina at strong light to prevent retina from strong light harm and hurt. In the long run, muscles to control pupil and crystalline lens become very tired and become flabby. Then the muscle can't adjust pupil and crystalline according to distance and brightness so that myopia is caused. (2) High frequency voltage causes lamp brightness changes too fast. Eyes can not adjust fast enough to follow the brightness change of lamp for high frequency voltage. But high frequency large current on the secondary cause high EMI that has risk to harm people's health. High frequency light causes EMI issue. Peoples' eyes can't keep up with high frequency light. Peak strong light shine on the retina for pupil can't shrink at high frequency light. In the long run, retina will be harmed and affect eyesight is affected, cornea dryness or crystalline lens opacity is caused. My invention of power supply lamp has only DC constant voltage on lamp. Lamp's brightness is constant and has no low frequency or high frequency component Thus peoples' eyes and health are protected to maximum extent. The output voltage is regulated at predetermined DC constant value by feedback. You can adjust feedback potentiometer value to set output voltage. Potentiometer and resistor voltage divider with auxiliary winding, (opto-coupler, digital isolator or direct feedback) compose the dimming feedback circuit. It is convenient to adjust the brightness of lamp for eyes' comfort by adjusting the potentiometer resistance value. My invention can be used directly on second category lamp that doesn't need high voltage with ballast to start the lamp. Most of them use heat generated by filament or diode etc to create light. Such as Halogen, Incandescent, LED, PAR lamp, miniature sealed beam lamp, Projection lamp, automotive lamp, some stage and studio lamp, DC fluorescent lamp etc. The converter realized pulse-by-pulse or other current limit protection by sense the current sense resistor or signal transformer.

One stage DC sinusoidal to DC constant converter 206 can be implemented by all kinds of topologies other than the following topologies as long as they can convert DC sinusoidal voltage to DC constant voltage. Buck, Boost, Buck-boost, Noninverting buck-boost ,H-Bridge, Watkins-Johnson, Current-fed bridge, Inverse of Watkins-Johnson, Cuk, SEPIC, Inverse of SEPIC, Buck square, full bridge, half bridge, Forward, Two-transistor Forward, Push-pull, Flyback, Push-pull converter basedon Watkins-Johnson, Isolated SEPIC, Isolated Inverse SEPIC, Isolated Cuk, Two-transistor Flyback etc

One stage AC to DC converter 206 can be realized by discrete components without controller 209, active startup circuit, feedback circuit or sample circuit. Main switch and active startup circuit can be integrated in IC controller. The AC to DC converter is not used only for lamp. It is can also be used for any device requires DC power supply in all the industrial areas. (Telecommunication, Storage, Personal computer, cell phone power supply and charger, video game etc) For example, Bus AC to DC converter, PFC converter, PFC converter for lighting Computer power supply, Monitor power supply, notebook adapter, LCD TV, AC/DC adapter, adjusted voltage charger, Power tool charger, Electronic ballast, Video game power supply etc.

### CROSS-REFERENCE AND CORRECTION TO RELATED APPLICATIONS

The present application claims priority to U.S. Patent Application No. 11/204,307, filed on Aug. 15, 2005, which is incorporated herein by reference in its entirety.

### BACKGROUND

The following disclosure relates to electrical circuits and signal processing.

Power supplies are used to power many types of electronic devices, for example, lamps. Conventional power supplies (e.g., for halogen lamps) typically include a converter. A converter is a power supply switching circuit.

Lamps have two categories:
First category uses ballast to strike the lamp to start. Most of them use gas to create light such as Fluorescent, HID, Compact, metal halide lamp etc. Bulbs need ballast because they use gas to create light. When the gas is excited by electricity, it emits invisible ultraviolet light that hits the white coating inside the bulb. The coating changes the ultraviolet light into light you can see. It needs a very high voltage strike to startup the operation of the lamp. But my invention is not applied directly to this category. The invention must be combined with second stage ballast to drive the lamp.
Second category doesn't need ballast to start the lamp. Most of them use heat generated by filament or diode etc to create light. Such as Halogen, Incandescent, LED, PAR lamp, miniature sealed beam lamp, Projection lamp, automotive lamp, some stage and studio lamp, DC fluorescent lamp etc.
My patent can be used directly on second category lamp.
Because Halogen lamp is the typical lamp of second category (filament or diode etc), all the discussion starts from the application of the power supply on Halogen lamp.

FIG. 1 shows a conventional half bridge converter 100 that receives AC sinusoidal voltage from a power source Vin. Converter 100 includes transistors Q1, Q2, transformer TI1, Coupled inductor T1A, T1B and T1C; DC blocking Capacitor C4, C5; Timing circuit C2, R2 and C3, R3; startup circuit D5, R4, Q3; R1, C1; bridge rectifier D1, D2, D3 and D4; AC power source 120Vac 60 Hz sinusoidal (or 220Vac 50 Hz) and Halogen lamp. (low voltage, for example 12v)

Q1 and Q2 complementary on/off with 50% duty cycle. Output voltage waveform is 120 Hz low frequency envelope with high switching frequency square waveform in it. As shown in FIG. 2 and FIG. 3.
Vo=60*(4/3.14159)*ns/np (np is primary turns and ns is secondary turns.)

Dimming is realized by applying phase cut dimmer in the converter in trailing edge mode. This means that at the beginning of the line voltage half cycle, the switch inside the dimmer is closed and mains voltage is supplied to the converter allowing the converter to operate normally. At some point during the half cycle, the switch inside the dimmer is opened and voltage is no longer applied. The DC bus inside the converter almost immediately drops to 0 V and the output is no longer present. In this way, bursts of high frequency output voltage are applied to the lamp. The RMS voltage across the lamp will naturally vary depending on the phase angle at which the dimmer switch switches off. In this way the lamp brightness may easily be varied from zero to maximum output as shown in FIG. 5 and 6.

Advantage of this typical low-voltage halogen-lamp converter 100 is simple without IC controller.

Disadvantage:
1. Output voltage has low frequency (120 Hz) envelope, voltage change from valley to peak 120 times per second. Lamp brightness is proportional to lamp voltage. So lamp brightness will change from darkest to brightest 120 times per second. Eyes pupil will open wide (mydriasis) when lamp becomes dark while eyes pupil will contract (myosis) while the crystalline lens also adjust according to different brightness. Thus the pupil will open and close 120 times per second. The muscle to control pupil and crystalline lens will become very tired for several hours. For long run, the muscle to control pupil and crystalline lens become limp and can't control well. Thus myopia is caused for crystalline lens can't be adjusted well according to distance.
2. High frequency (switching frequency) square waveform in the envelope cause EMI issue and has risk to harm people's health. Pupil open wide at darkness and contract at brightness to protect retina. Eyes pupil can't keep pace with high frequency light. Thus the retina will be harmed by peak brighness light in high frequency light.
3. Crest factor is high (17/12=1.4167) and shorten lamp's life.
4. Variation output voltage for No Feedback;
5. Dimming needs external dimmer based on turn on/off line voltage. So cost increases.
6. Power factor is very low during dimming at low voltage.
7. Inrush current during turn on is high and shortens the lamp life.

FIG. 4 shows another way to drive the halogen lamp. A low frequency transformer is connected directly to the halogen lamp.
Advantage: Component is only one transformer and cost is less.
Disadvantage:
1. Output voltage has low frequency sinusoidal waveform, thus human's eyes will feel tired under the low frequency flicker; it cause myopia for long term.
2. Variation output voltage for No Feedback;
3. Dimming needs external dimmer based on turn on/off line voltage, so the Power factor is very low during dimming, Inrush current during turn on is high and shorten the lamp life.
4. Transformer is too big and heavy for low frequency use.

### SUMMARY

In general, in one aspect, this specification describes new block diagram for Halogen lamp converter as FIG. 7 and new topology as FIG. 11,12,13,14,15,16,17,24,25,26,27,28,29,30,31,32,33,34,35,36,37,38,39,40,41,42,43,44,45,46, 47,48,49,50,51,52 and 53.

Implementations can include one or more of the following advantages.
1. Output voltage is DC constant voltage. No low frequency component and no high frequency component. It protects peoples' eyesight and health to maximum extent.
(Low frequency component cause eyes tired and myopia for long term.
High frequency component cause EMI issue and harm to people's health. Eyes pupil can't keep pace with high frequency light. Thus the retina will be harmed by peak bright light under high frequency light.)
2. Output voltage has feedback control and is constant without varying voltage magnitude in normal operation or dimming. Crest factor is 1 so that lamp's life is extended to maximum degree.
3. Dimming is realized by changing potentiometer resistance value. No need for external dimmer and save cost. Dimming does not turn on/off circuit and does not cause inrush current or ugly waveform. So lamp's life is prolonged.
3. Power factor correction circuit is included in one implementation like IW2202, So power factor is unity even at dimming and efficiency is high; Power factor correction is not included in one implementation like IW2210, LNK302/304-306, LNK362-364 or UCC28600 etc

Traditional PFC only use boost (FIG. 34) converter to realize AC to DC conversion. But boost converter can only output DC voltage higher than the peak of input AC voltage. Most of lamps rating voltage are less than peak of input AC line voltage (170v). So traditional PFC boost converter can't be directly used for low voltage lamp. My invention can buck down the voltage. Output DC voltage can be lower or higher than input AC peak voltage or equal to input AC peak voltage. My invention can be directly used for any rating voltage lamp of any kind without ballast requirement.

The details of one or more implementations are set forth in the accompanying drawings and the description below. Other features and advantages will be apparent from the description and drawings, and from the claims.

### DESCRIPTION OF DRAWINGS

FIG. 1: typical low-voltage halogen-lamp power supply based on conventional half bridge converter 100.

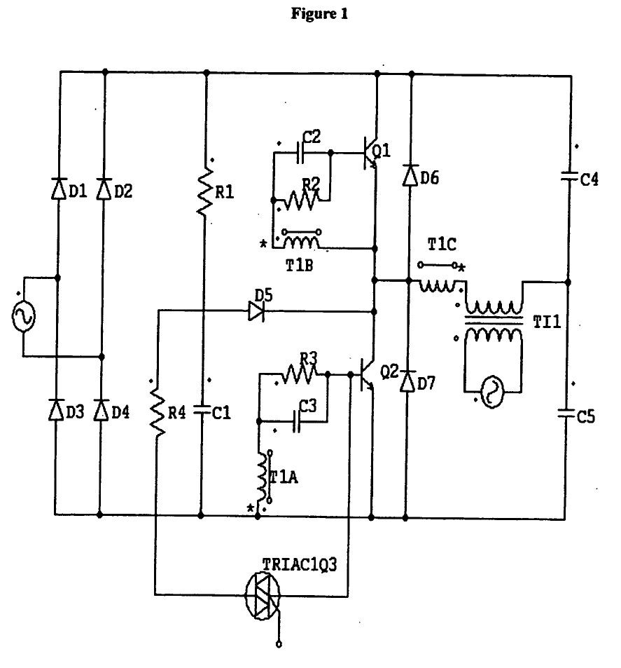

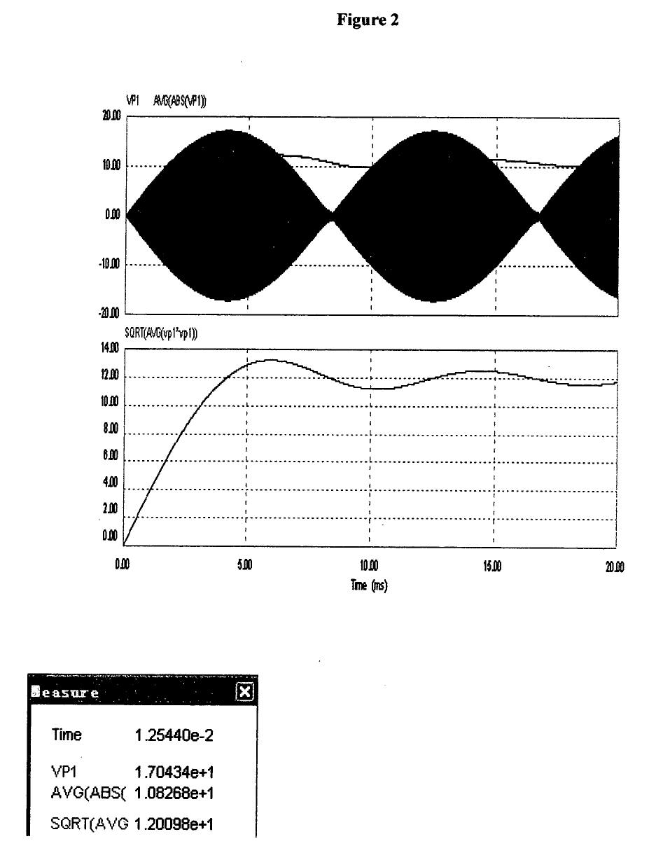

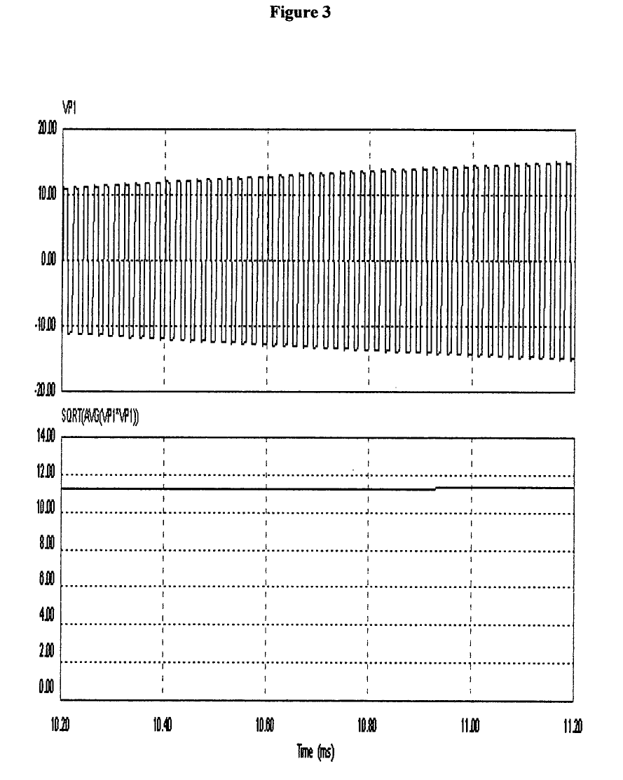

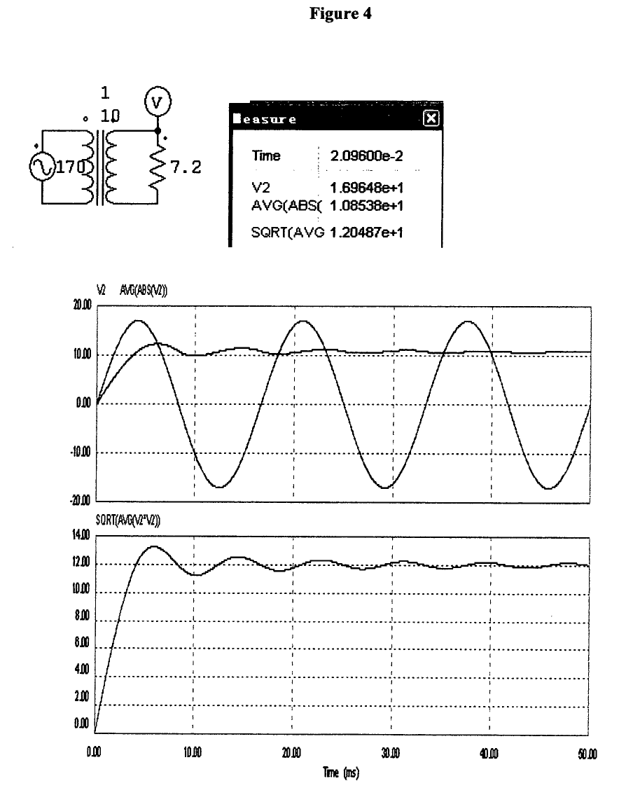

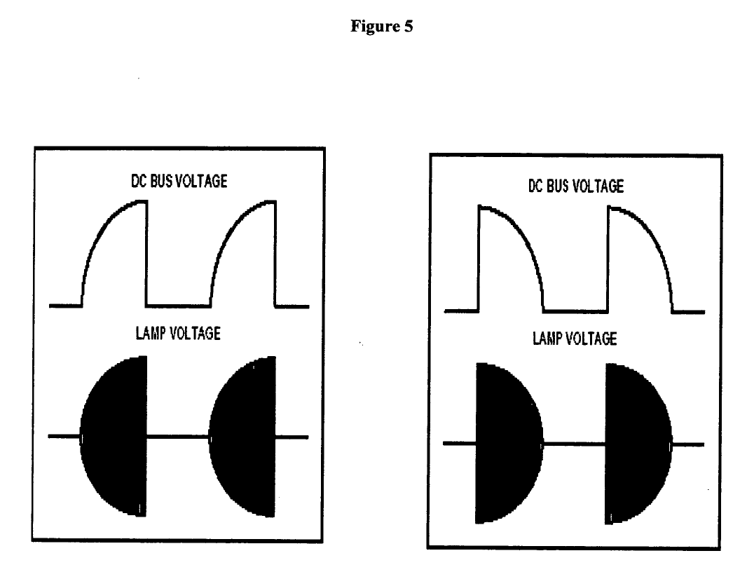

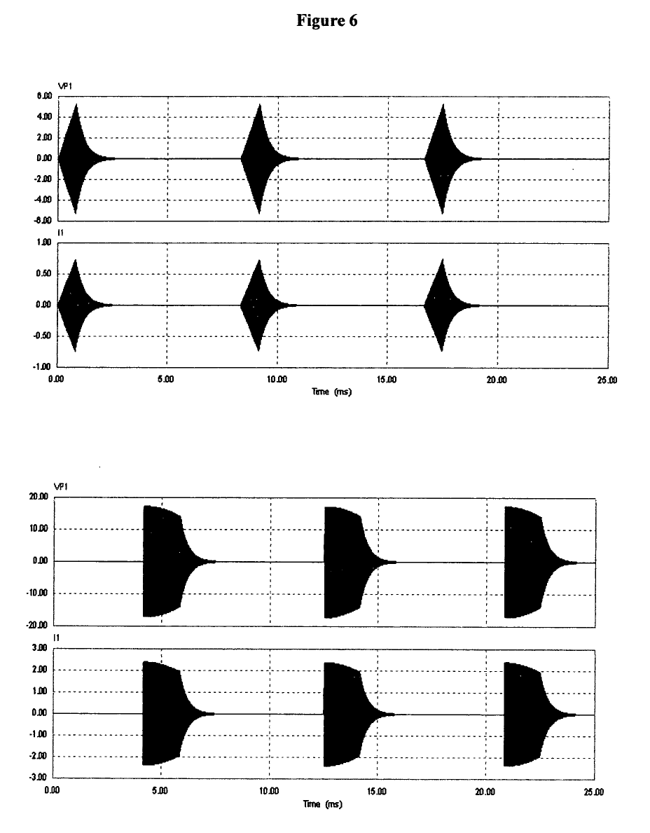

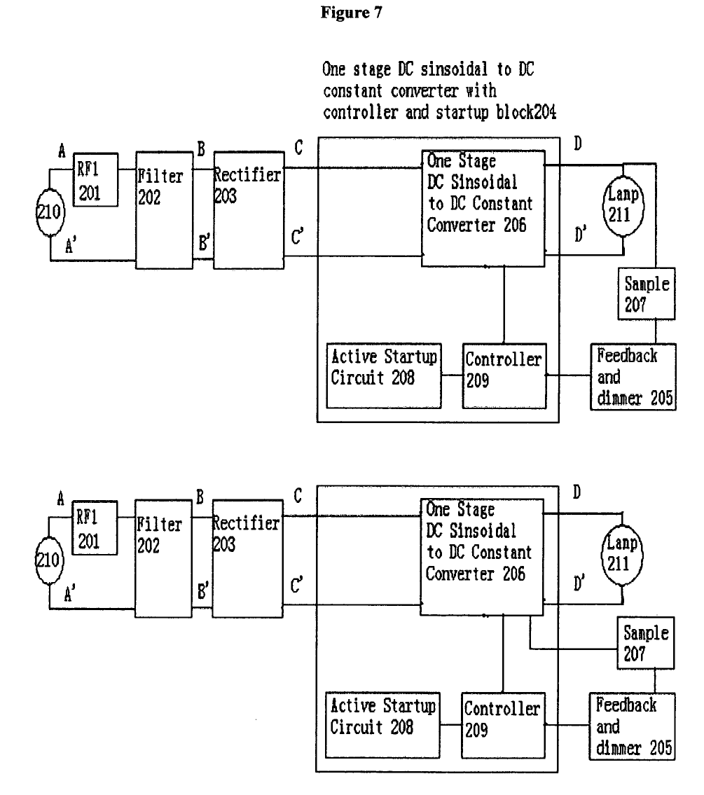

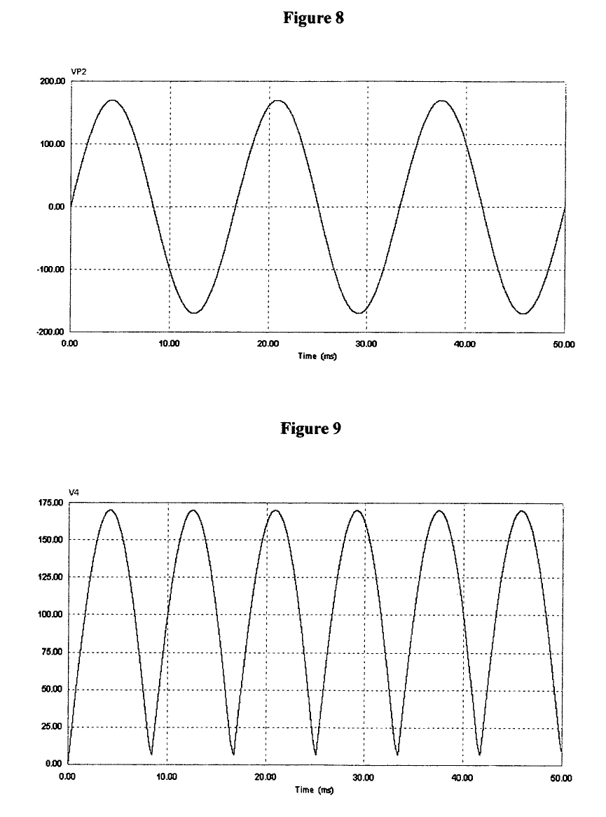

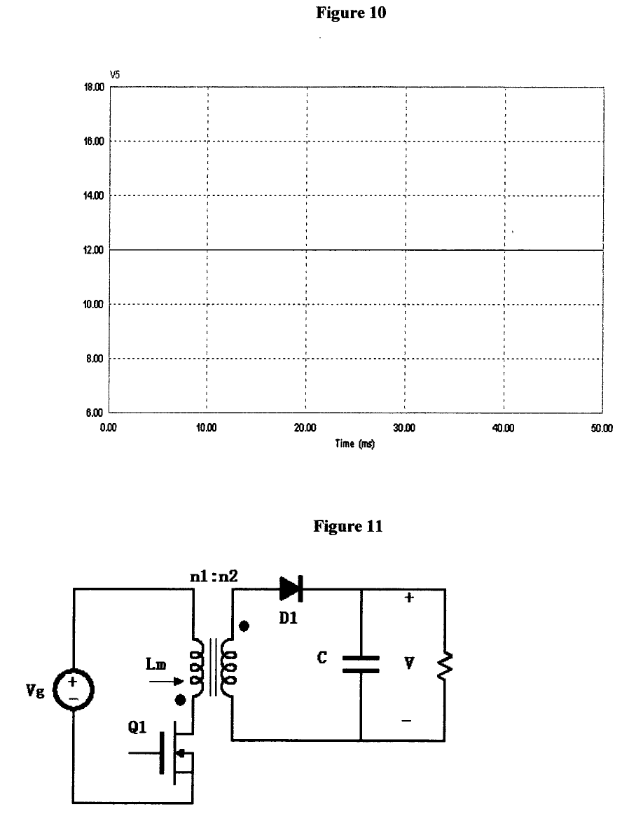

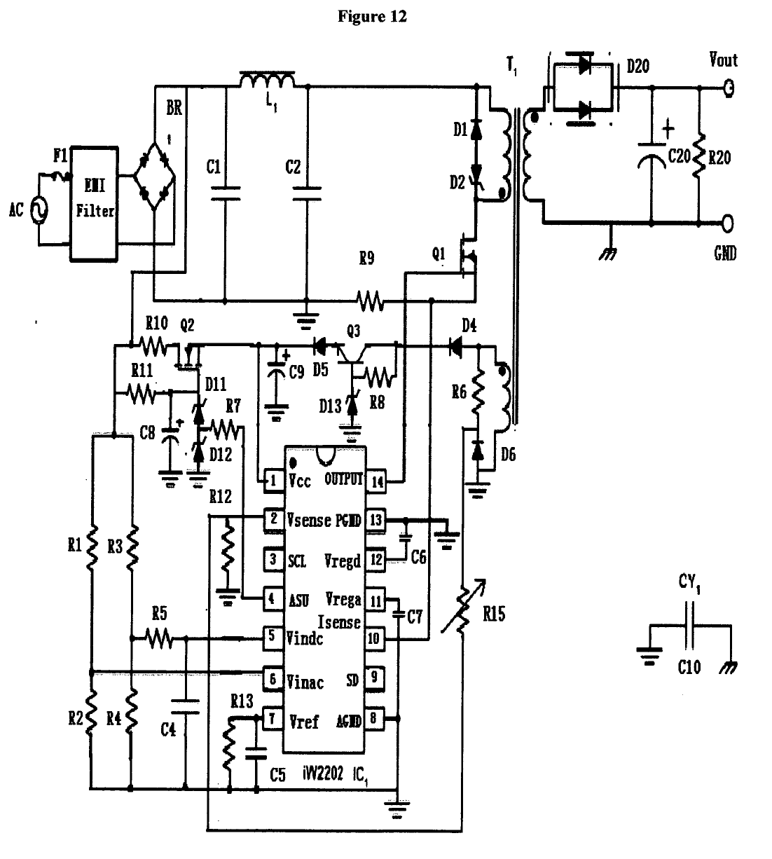

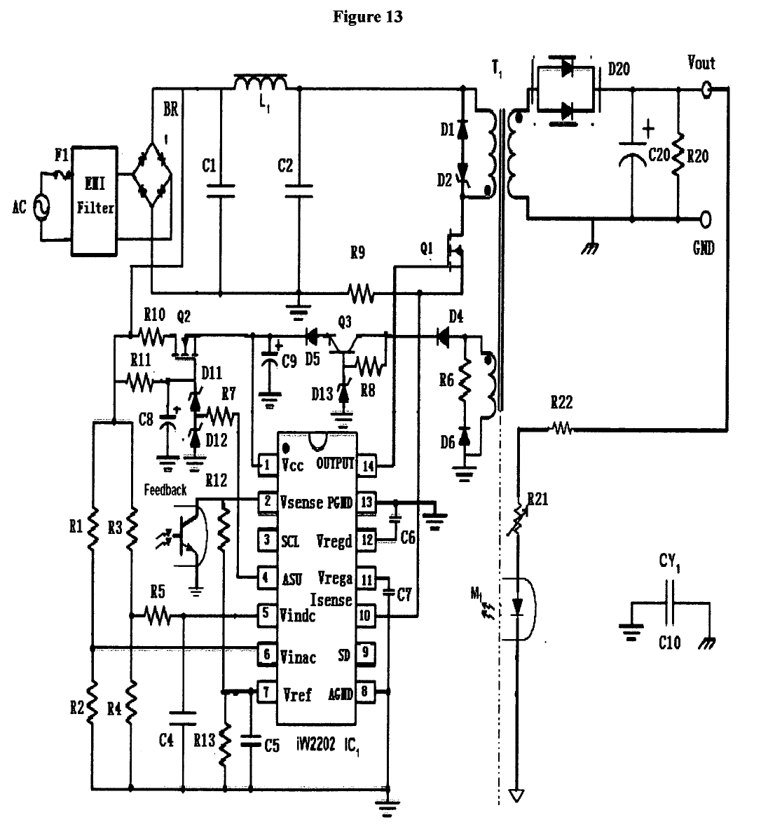

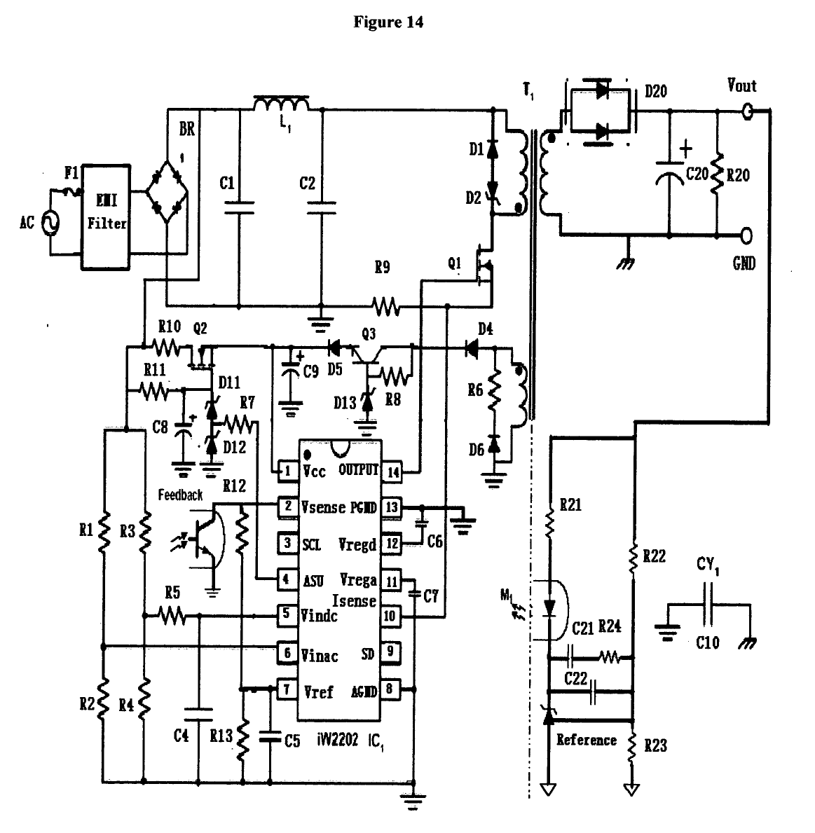

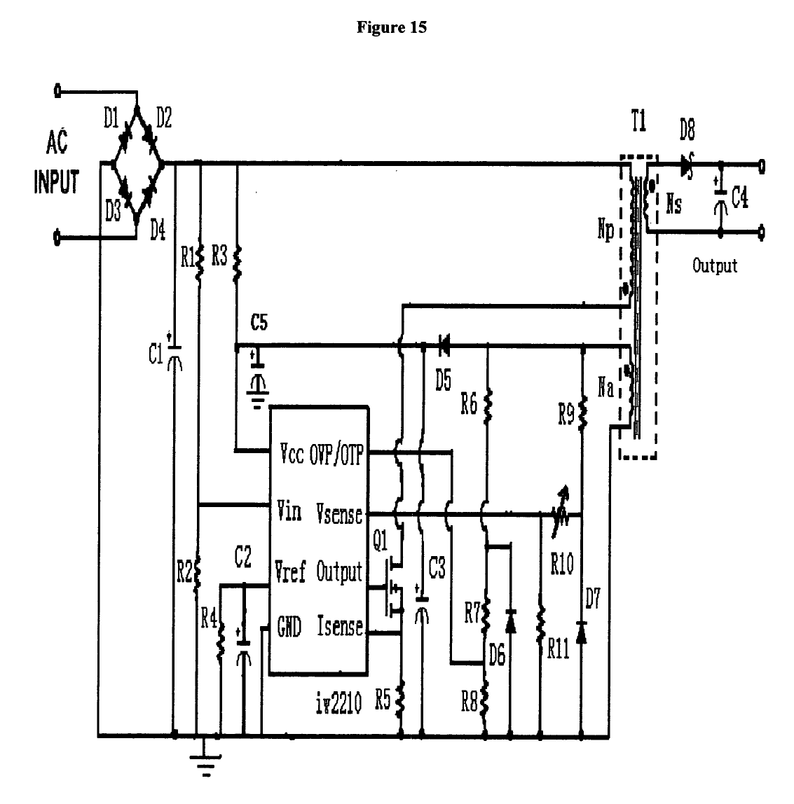

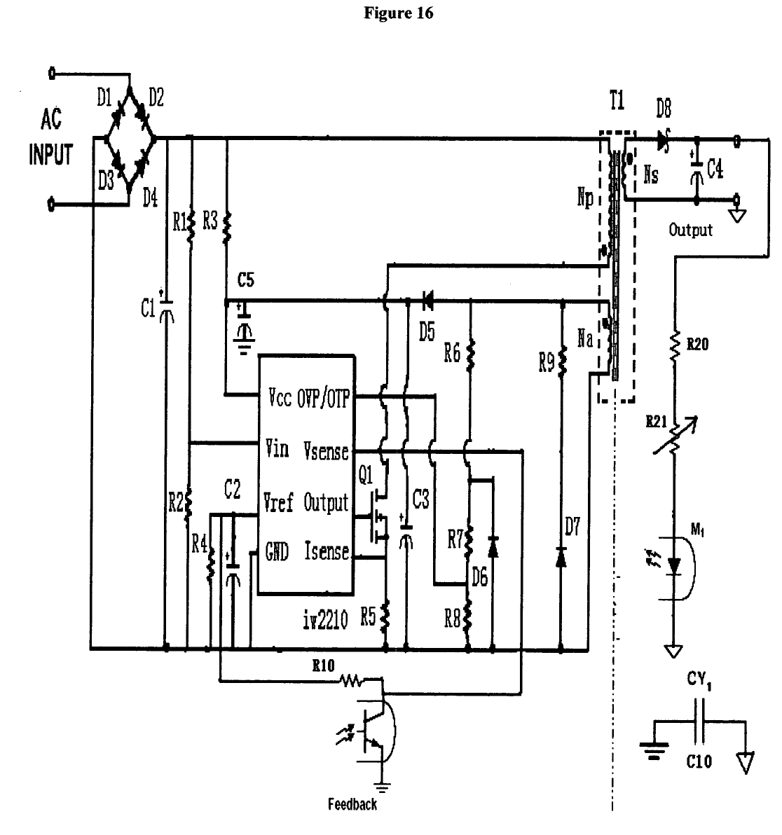

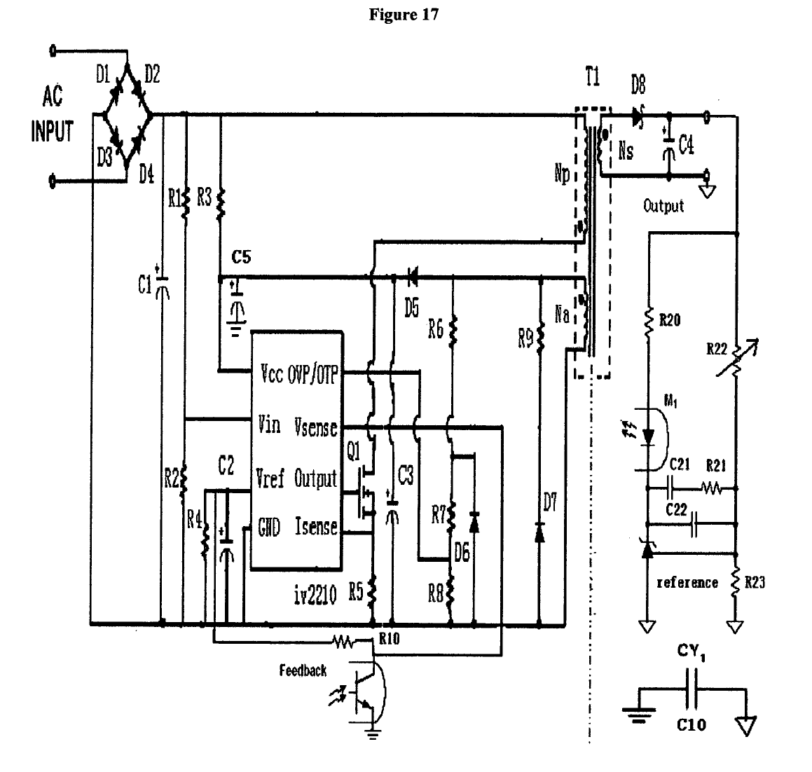

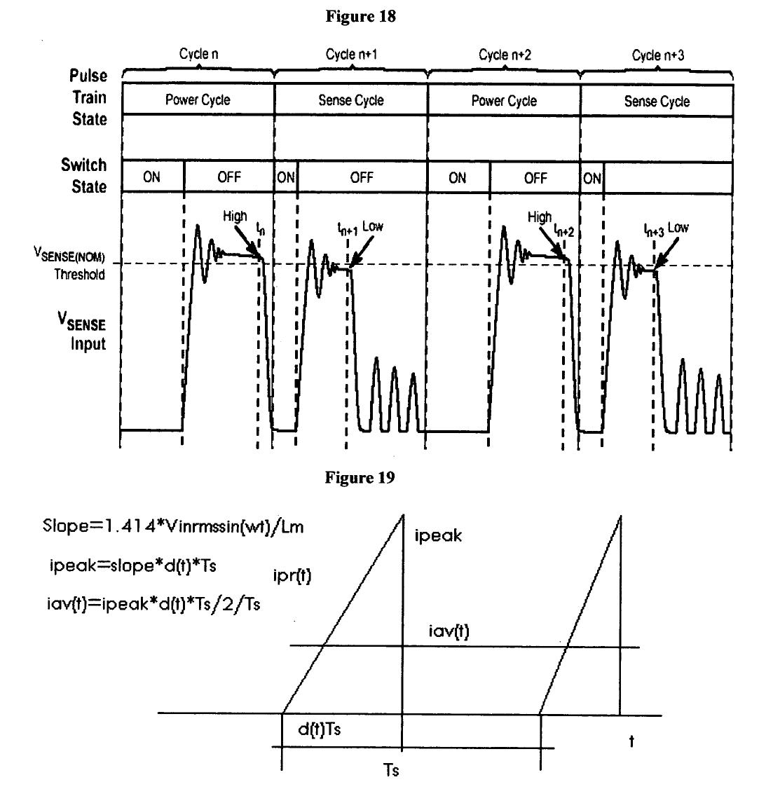

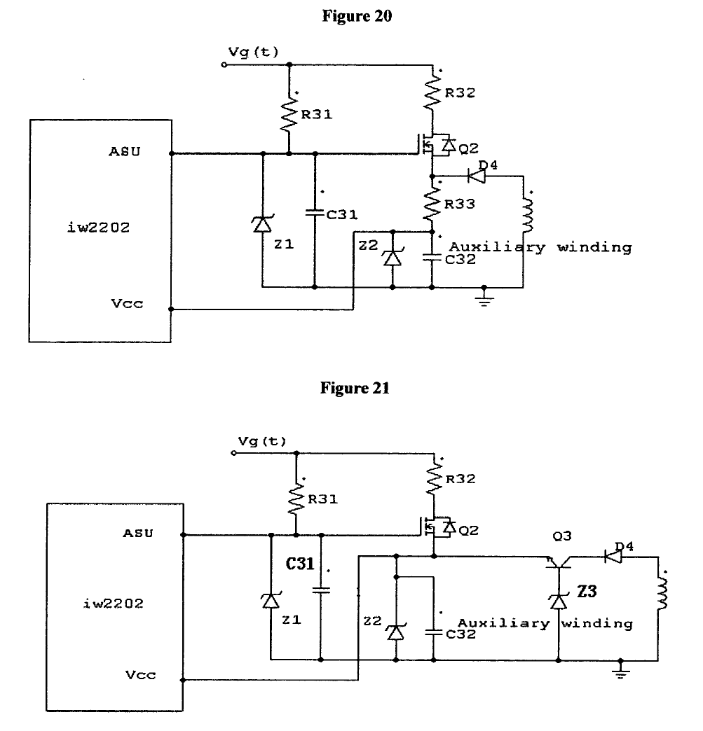

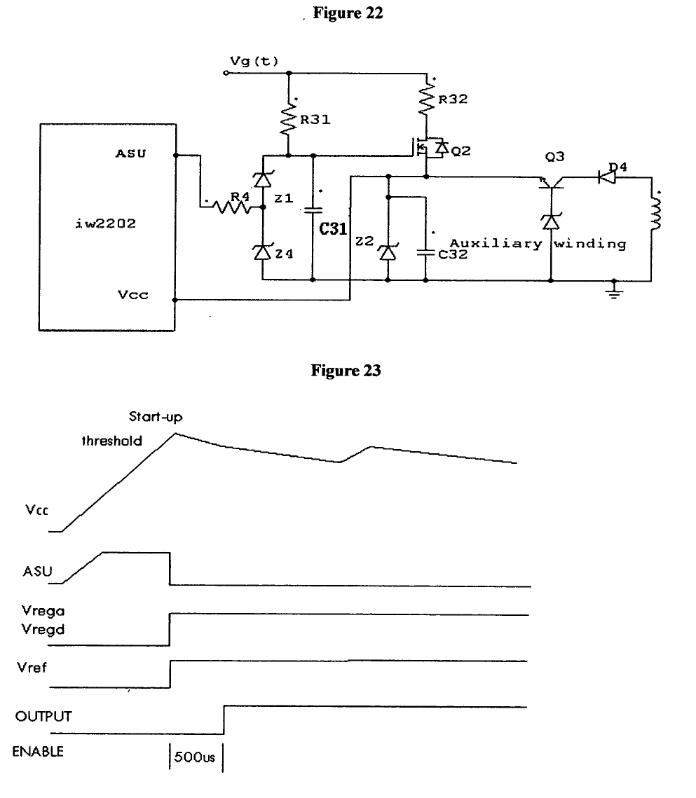

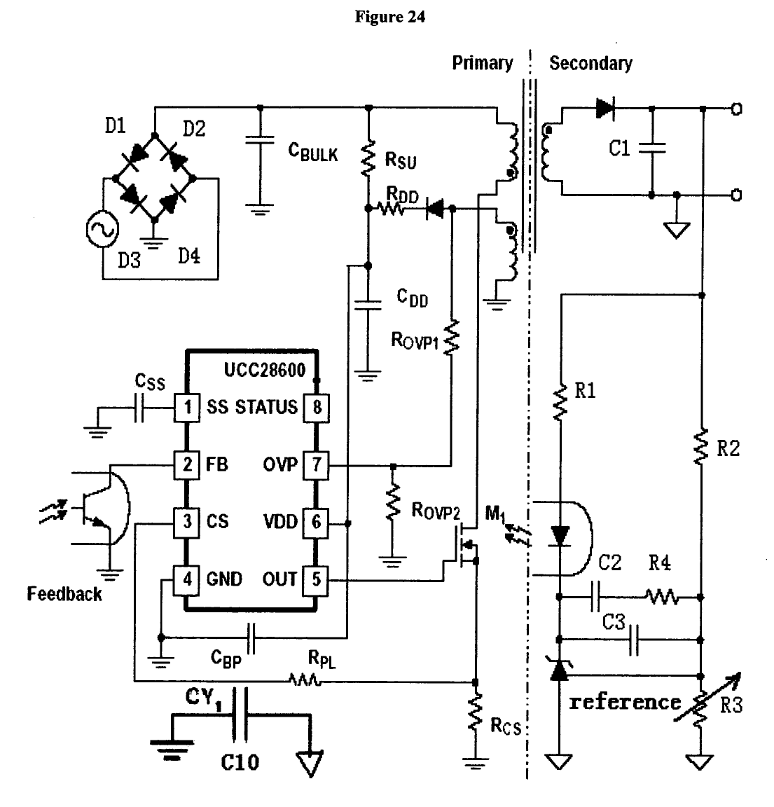

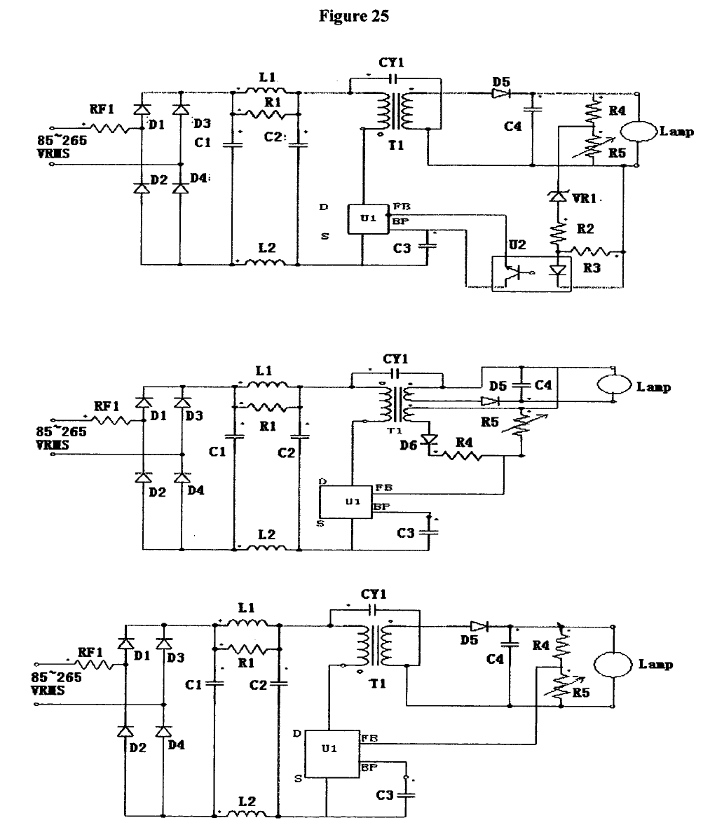

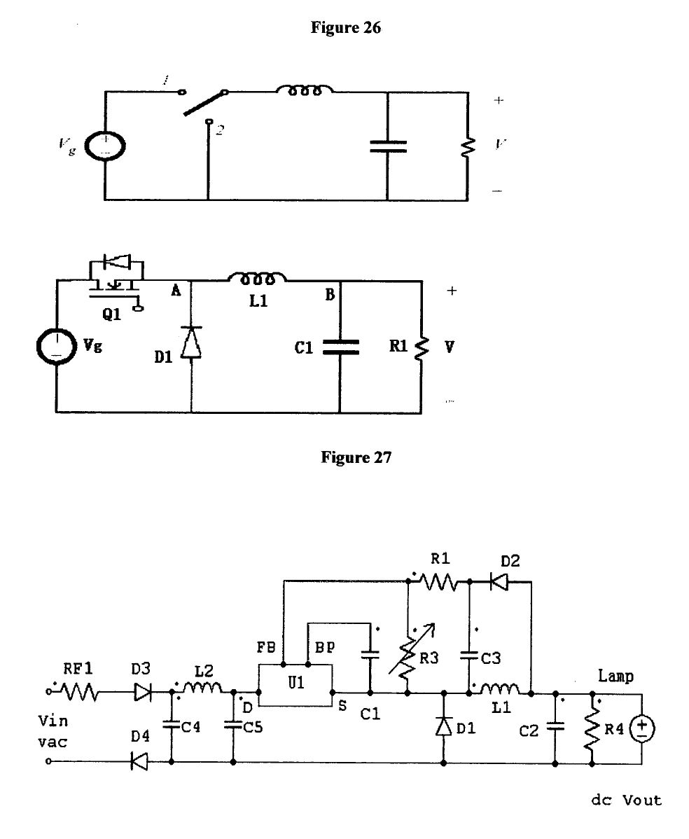

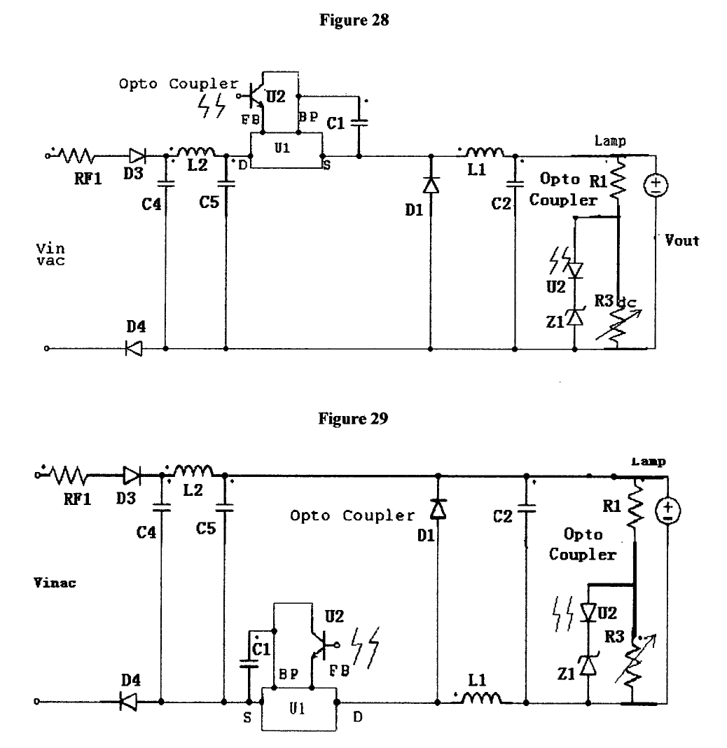

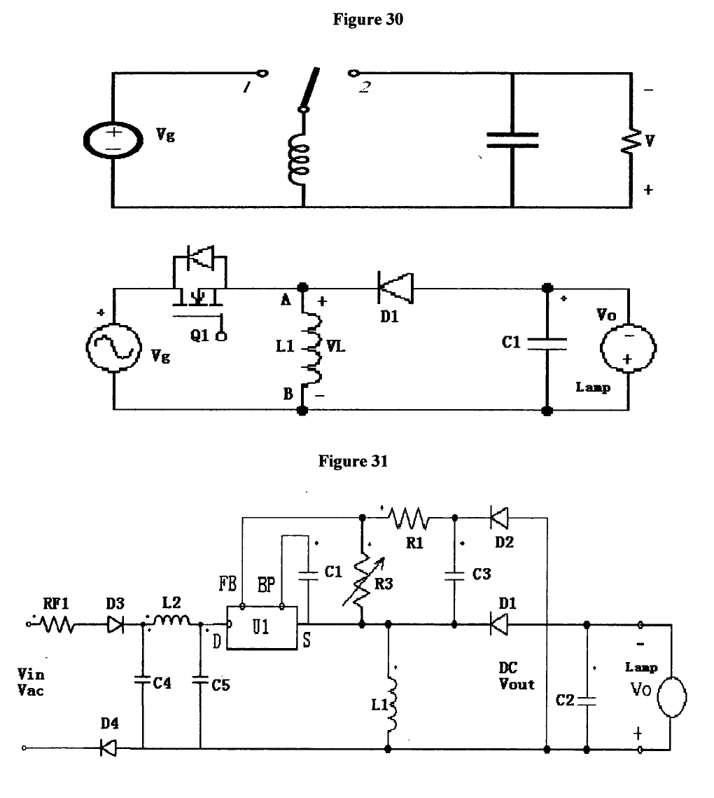

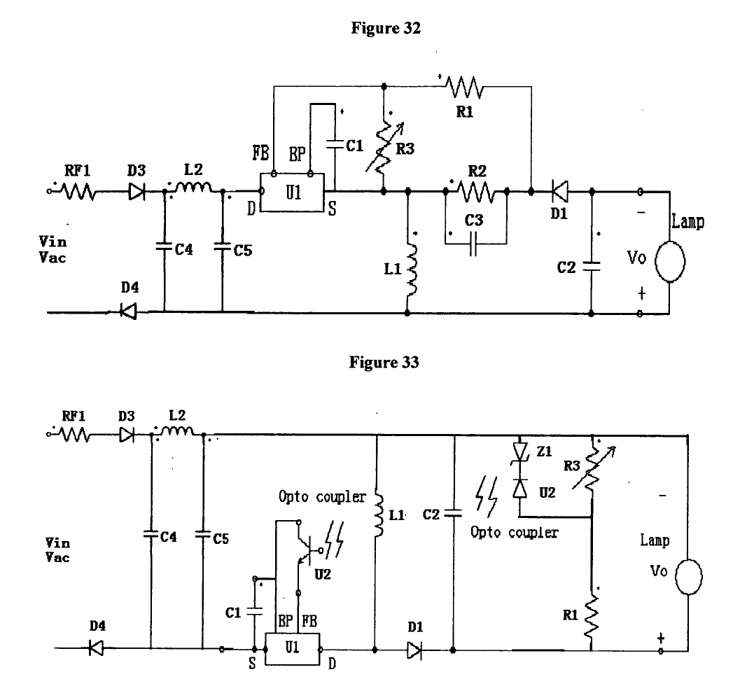

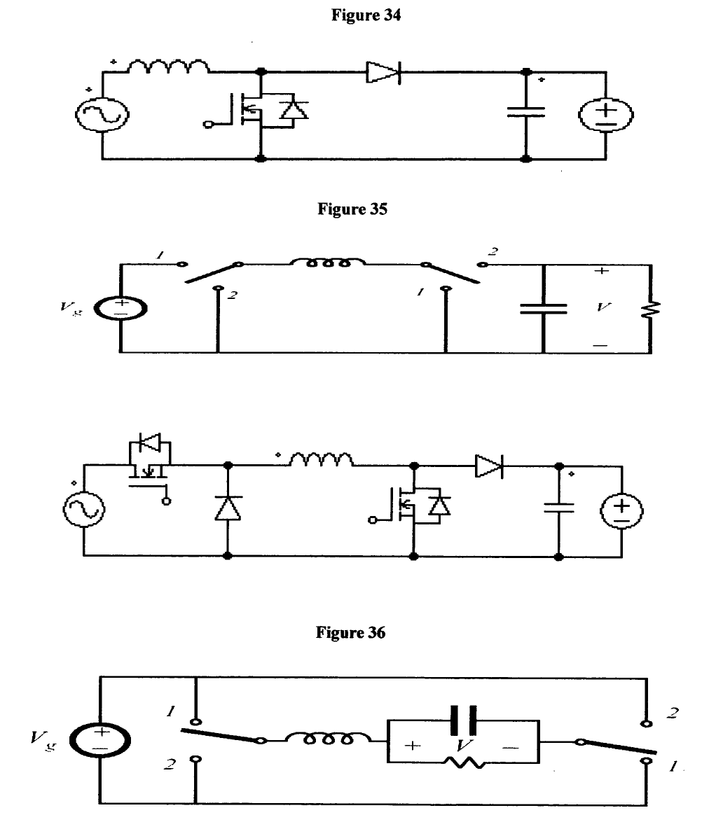

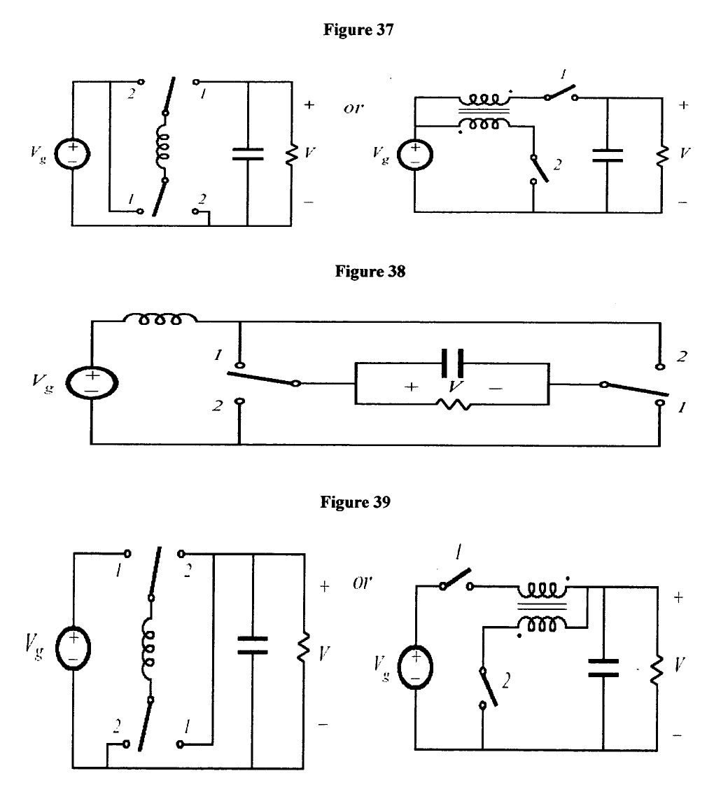

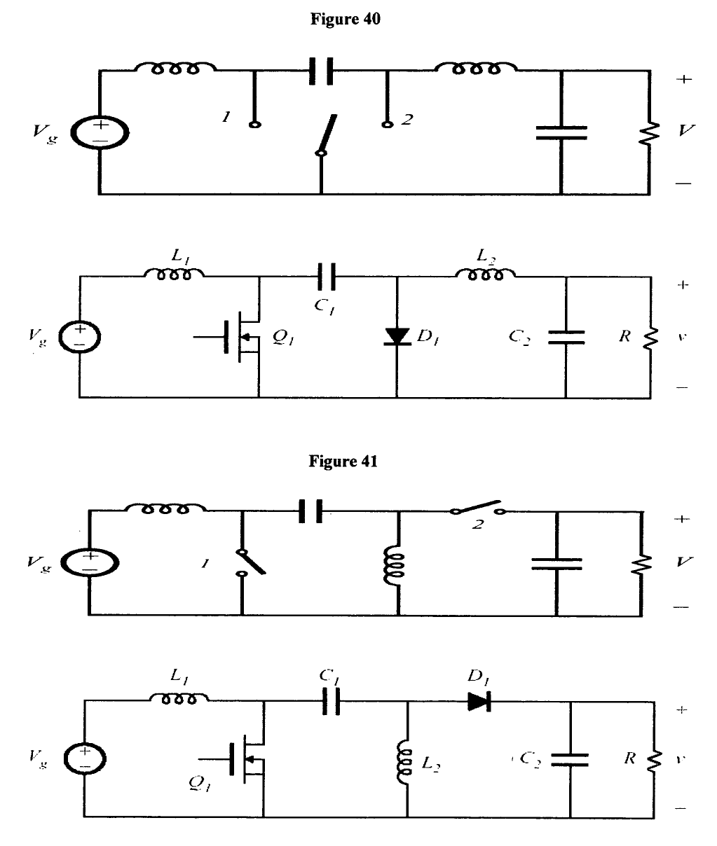

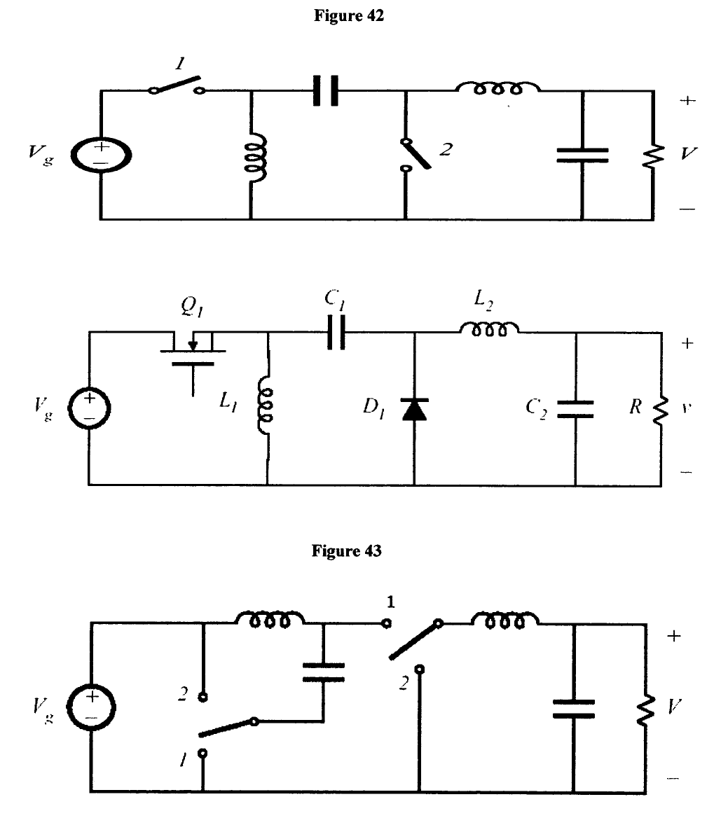

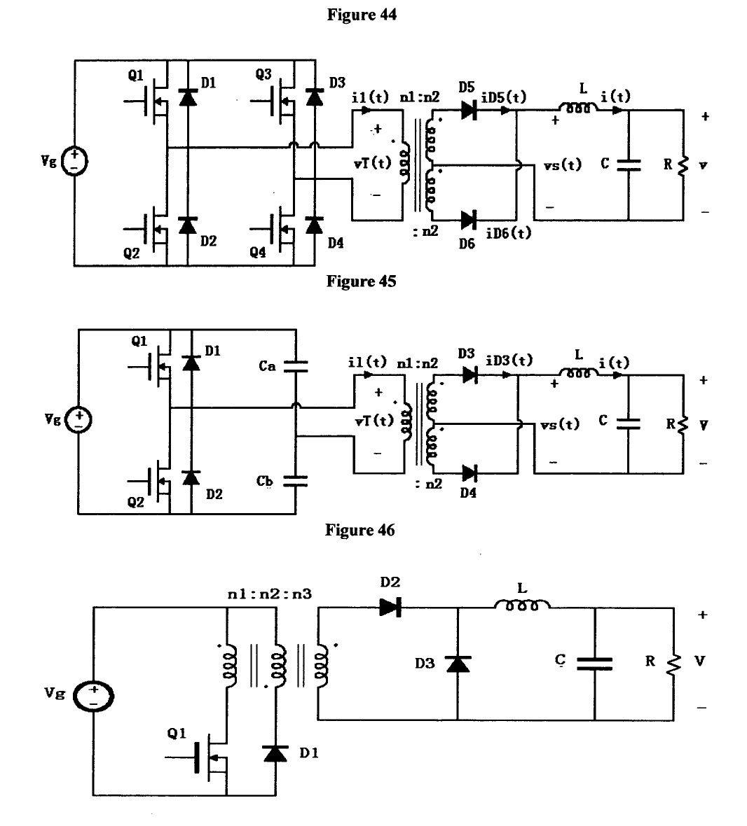

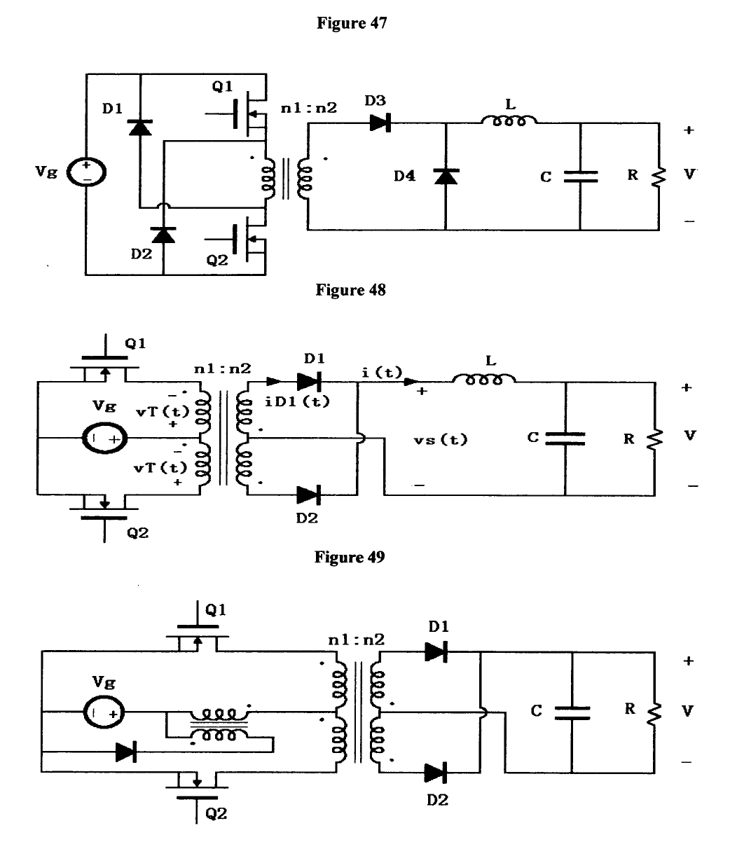

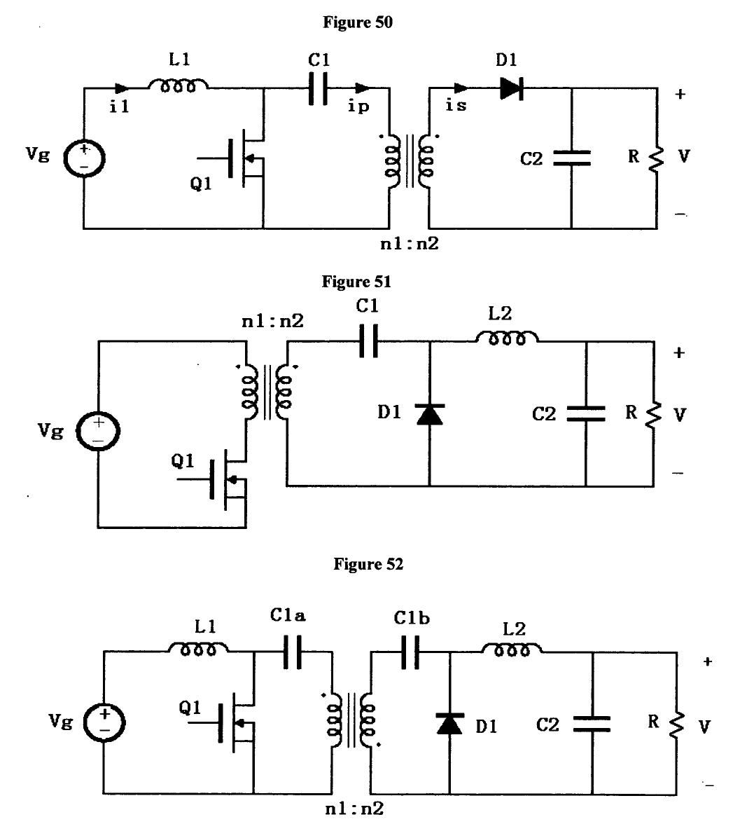

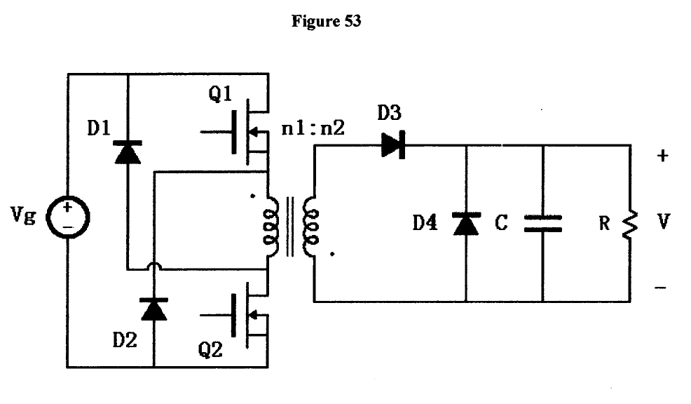

FIG. 2: Output voltage waveform of typical halogen lamp power supply based on half bridge converter 100 is high frequency square waveform contained in low frequency (120 Hz) envelope.
Top graph: Blue or red curve-rms value of output voltage across lamp;
Red shade-output voltage waveform across lamp.
Bottom table: VP1-Peak value of output voltage; SQRT(AVG-rms value of output voltage.

FIG. 3: amplified high frequency square waveform contained in the low frequency envelope of output voltage in typical halogen lamp converter 100.
Top: Red waveform-high frequency square waveform in output voltage
Bottom: rms value of output voltage

FIG. 4: The halogen lamp converter driven directly by a big low frequency transformer and output voltage on the lamp.
Top table: V2-peak value of output voltage; SQRT(AVG-rms value of output voltage.
Top waveform: red-sinusoidal output voltage; blue-rms value of output voltage
Bottom waveform: red-rms value of output voltage

FIG. 5: input bus voltage and lamp output voltage waveform during dimming with external dimmer for typical Halogen lamp converter 100.
Left: trailing edge dimming
Right: Leading edge dimming

FIG. 6: Output voltage and current of lamp during dimming of typical halogen lamp converter 100.
Top: trailing edge dimming
Bottom: Leading edge dimming

FIG. 7: Block diagram of my invention, Power Supply 200, AC to DC power supply with PFC (or without PFC) for Lamp

FIG. 8. Voltage waveform across A and A′ on block diagram FIG. 7

FIG. 9. Voltage waveform across C and C′ on block diagram FIG. 7

FIG. 10. Voltage waveform across D and D′ on block diagram FIG. 7

FIG. 11. Flyback converter used as converter 206 in block diagram FIG. 7 Vo=Vg*D*n2/(D′*n1)

FIG. 12. One implementation schematic of my invention using Flyback topology for converter 206 and IW2202 for controller 209 with PFC function.(primary dimming control)

FIG. 13. One implementation schematic of my invention using Flyback topology for converter 206 and IW2202 for controller 209 with PFC ftinction.(secondary dimming control)

FIG. 14. One implementation schematic of my invention using Flyback topology for converter 206 and IW2202 for controller 209 with PFC function.(secondary dimming control)

FIG. 15. One implementation schematic of my invention using Flyback topology for converter 206 and IW2210 for controller 209 without PFC function.(primary dimming control)

FIG. 16. One implementation schematic of my invention using Flyback topology for converter 206 and IW2210 for controller 209 without PFC function.(secondary dimming control)

FIG. 17. One implementation schematic of my invention using Flyback topology for converter 206 and IW2210 for controller 209 without PFC function. (secondary dimming control)

FIG. 18. Pulse train algorithm in IW2210 for controller 209.

FIG. 19. The input current waveform with input voltage through switching Mosfet, Vinrms=input rms voltage; Lm=magnetic inductance of transformer; d(t):duty cycle; Ts: period. Ipeak=peak value of current through switching Mosfet iav(t):average value of current through switch Mosfet. Slope: Mosfet switch current slope.

FIG. 20. One implementation schematic of active startup circuit 208

FIG. 21. One implementation schematic of active startup circuit 208

FIG. 22. One implementation schematic of active startup circuit 208

FIG. 23. Startup Timing Diagram on pins of IC controller in one implementation with IW2202

FIG. 24. One implementation schematic of my invention using Flyback topology for converter 206 and UCC28600 for controller 209 without PFC function.(secondary dimming control)

FIG. 25. One implementation schematic of my invention using Flyback topology for converter 206 and U1 for controller 209 without PFC function. In one implementation, U1 is IC controller LNK362, LNK363 or LNK364 etc.

FIG. 26. Buck converter for converter 206 Vo/vin=D

FIG. 27. One implementation schematic of my invention using Buck topology for converter 206 and U1 for controller 209 without PFC function. In one implementation, U1 is IC controller LNK302, LNK304, LNK305 or LNK306 etc. Direct feedback.

FIG. 28. One implementation schematic of my invention using Buck topology for converter 206 and U1 for controller 209 without PFC function. In one implementation, U1 is IC controller LNK302, LNK304, LNK305 or LNK306 etc. High side buck-opto coupler feedback

FIG. 29. One implementation schematic of my invention using Buck topology for converter 206 and U1 for controller 209 without PFC function. In one implementation, U1 is IC controller LNK302, LNK304, LNK305 or LNK306 etc. Low side buck-opto coupler feedback

FIG. 30. Buck-boost converter for converter 206 Vo/vin=-D/(1−D)

FIG. 31. One implementation schematic of my invention using Buck-Boost topology for converter 206 and U1 for controller 209 without PFC function. In one implementation, U1 is IC controller LNK302, LNK304, LNK305 or LNK306 etc. High side buck boost-direct feedback

FIG. 32. One implementation schematic of my invention using Buck-Boost topology for converter 206 and U1 for controller 209 without PFC function. In one implementation, U1 is IC controller LNK302, LNK304, LNK305 or LNK306 etc. High-Side Buck Boost-Constant current feedback

FIG. 33. One implementation schematic of my invention using Buck-Boost topology for converter 206 and U1 for controller 209 without PFC function. In one implementation, U1 is IC controller LNK302, LNK304, LNK305 or LNK306 etc. Low-Side Buck Boost-Optocoupler feedback

FIG. 34. Boost converter for converter 206 Vo/vin=1(1−D)

FIG. 35 Noninverting buck-boost converter for converter 206 Vo/vin=D/(1−D)

FIG. 36 H-Bridge converter for converter 206 Vo/Vin=2D−1

FIG. 37 Watkins-Johnson converter for converter 206 Vo/vin=(2D−1)/D

FIG. 38 Current-fed bridge converter for converter 206 Vo/vin=1/(2D−1)

FIG. 39 Inverse of Watkins-Johnson converter for converter 206 Vo/vin=D/(2D−1)

FIG. 40. Cuk converter for converter 206 Vo/vin=−D/(1−D)

FIG. 41. SEPIC converter for converter 206 Vo/vin=D/(1−D)

FIG. 42. Inverse of SEPIC converter for converter 206 Vo/vin=D/(1−D)

FIG. 43. Buck square converter for converter 206 Vo/Vin=D*D

FIG. 44. Full bridge converter for converter 206 Vo/Vin=n2*D/n1

FIG. 45 Half bridge converter for converter 206 Vo/Vin=0.5*n2*D/n1

FIG. 46 Forward converter for converter 206 Vo/Vin=(n3/n1)*D

FIG. 47 Two transistor forward converter for converter 206 Vo/Vin=n2*D/n1

FIG. 48 Push pull converter for converter 206 Vo/Vin=n2*D/n1

FIG. 49. Push pull based on Watkins-Johnson for converter 206; Vo/Vin=(n2/n1)*(2*D−1)/D

FIG. 50. Isolated SEPIC converter for converter 206 Vo/Vin=(n2/n1)*D/D′

FIG. 51. Isolated Inverse SEPIC converter for converter 206 Vo/Vin=(n2/n1)*D/D′

FIG. 52 Isolated Cuk converter for converter 206 Vo/Vin=(n2/n1)*D/D′

FIG. 53 Two-transistor Flyback converter for converter 206 Vo/Vin=(n2/n1)*D/D′

### DETAILED DESCRIPTION

FIG. 7 is a block diagram of a power supply 200 for a connected output device (e.g., lamp 211). In one implementation, power supply 200 receives an AC source voltage from a voltage source 210. In one implementation, power supply 200 includes an RF1 201, an input filter 202, a rectifier 203, an one stage substantially DC sinusoidal to constant DC voltage converter 206, a controller 209, feedback and dimmer circuit 205, sample circuit 207, active startup circuit 208 and Lamp 211. The power supply can have more blocks or fewer blocks than FIG. 7. (For example, 206,208,209 can be an integrated block 204 or 208 can be removed in some implementation. Main switch of converter 206 and 208 can be integrated into the controller 209 as in LNK302/304-306 or LNK362-364). The sequence and position of some blocks can be exchanged. (For example, position of 202 and 203 can be exchanged). Each block can use all kinds of different circuits with function as the following.

Input RF1 201 provides input current protection for converter 200. In particular, in one implementation, input fise is designed to provide current protection for converter 206 by cutting off current flow to converter 206 in an event that current being drawn through input fuse 201 exceeds a predetermined design rating. In another implementation, RF1 201 is a flameproof, fusible, wire wound type and functions as a fuse, inrush current limiter. In another implementation, RF1 210 can be a NTC or PTC thermistor.

Input filter 202 minimizes an effect of electromagnetic interference (EMI) on power supply 200, converter 206 and exterior power system. Input filter 202 can be LC filter π filter, common mode filter, differential mode filter or any type filter that provide a low impedance path for high-frequency noise to protect power supply 200 and exterior power system from EMI. Input filter 202 can be placed in front of rectifier 203 or behind rectifier 203.

Rectifier 203 converts the input AC source voltage from voltage source 210 (like FIG. 8) into a substantially DC sinusoidal voltage (like FIG. 9).

In one implementation, rectifier 203 is a full-wave rectifier that includes four rectifiers in a bridge configuration as in FIG. 12, 13 or 14 etc. In another implementation, rectifier 203 contains 2 diodes as shown in FIG. 27,28 or 29 etc. Rectifier can be any type or bridgeless PFC.

One stage DC sinusoidal voltage to constant DC voltage converter 206 converts the substantially DC sinusoidal voltage like FIG. 9 received from rectifier 203 into a DC constant voltage at predetermined value suitable to support an output device (e.g., halogen lamp 211). In one implementation, converter 206 converts the substantially DC sinusoidal voltage received from rectifier 203 into DC constant voltage 12 volts. (FIG. 10) Usually the input voltage source 210 comes from 60 Hz 110v AC or 50 Hz 220v AC sinusoidal line voltage in power system.

Controller 209 is operable to regulate output voltage at predetermined value.

Controller 209 can be any type and have any type of control with PFC or without PFC function. (Such as digital control, analogy control, DSP, bang-bang control, skipping switching cycles as in LNK302/304-306, Pulse Train control as in IW2210 etc.)

In such an implementation, controller 209 is operable to adjust the duty cycle, switching frequency or on time of main switch of converter 206 so that converter 206 outputs a DC constant output voltage having a predetermined voltage value. Controller 209 can control an output voltage level of converter 206 responsive to a predetermined value set by voltage divider composed of potentiometer and resistor at dimming or normal operating.

Normal operating; predetermined value set to rating voltage of lamp; dimming operating, predetermined value set to lower voltage than rating voltage of lamp.

Feedback control voltage comes from feedback circuit 205, as discussed in greater detail below.

Sample circuit 207 sense the signal proportional to output DC constant voltage or directly sense the voltage cross the lamp.

Feedback and dimmer circuit 205 is operable to provide a feedback dimming control voltage to controller 209 for dimming (or reducing) output voltage (e.g., halogen lamp 211) by changing potentiometer value to change voltage divider ratio. Duty cycle, switching frequency or on time of main switch are changed to change output voltage.

In one implementation (non-isolated feedback), 205 can be realized by a voltage divider composed of potentiometer and resistor (or zener diode and resistor voltage divider) and voltage cross one resistor goes to Feedback pin of controller 209;

In one implementation (isolated feedback), 205 can be realized by a voltage divider composed of potentiometer and resistor (or zener diode and resistor voltage divider) and voltage across one resistor or voltage across secondary winding is coupled to Feedback pin of controller 209 by auxiliary winding, opto-coupler or digital isolator etc

In real application, block can be more or less than FIG. 7. Some blocks maybe different from FIG. 7. For example, some application had no feedback function.

### Type I. Isolated Converter

### I-1 Part 1 Flyback Converter Used as Converter 206

Flyback converter is shown in FIG. 11. The function is described as the following: when Q1 on, all magnetic winding has positive voltage on no ‘•’ end with respect to the other end. D1 is off; when Q1 off, all magnetic winding has positive voltage on ‘•’ end with respect to the other end, D1 turns on, energy transfer to output load.

During Q1 on, 0<t<DTs, voltage across transformer primary winding is Vg. (Vg input voltage). During Q1 off, DTs<t<Ts, voltage across transformer primary winding is −Vo*n1/n2. (Vo is output voltage, n1 is primary turns; n2 is secondary turns.) In continues conduction mode, primary winding balance: D is duty cycle, D′=1−D
Vg*D*Ts−Vo*D′*Ts*n1/n2=0Vo=Vg*D*n2/(D′*n1)

### I-1.1 Power Supply with PFC Based on Flyback Converter

### (In One Implementation, IW2202 is Used as Controller)

The detail is discussed below.

FIG. 12,13 and 14 illustrate one implementation of a converter that can be used within power supply 200. Referring to FIG. 12,13 and 14, my invention converter 200 is implemented with Flyback topology for converter 206 and IC IW2202 for controller 209. The following discussion starts from IC IW2202. In application, the circuit can have more or less components than FIG. 12,13 and 14. We started the discussion with FIG. 11.

During the period when Q1 is on (0<t<=DTs), the ‘•’ end is negative with respect to no ‘•’ end of primary and secondary transformer windings, thus diode D3 could not turn on. Energy is saved in the magnetic inductance Lm. The voltage cross primary winding is Vg. (Vg is voltage after AC voltage rectified, In one implementation, Vg is DC sinusoidal voltage like FIG. 9)

During the period when Q1 is off (DTs<=t<Ts), the polarity of the transformer winding changes. ‘•’ end is positive with respect to no ‘•’ end for both primary and secondary winding of transformer. Thus D3 turns on; energy is delivered to the output. The voltage cross primary winding is Vo*np/ns. (Vo is output DC voltage and np is primary turns; ns is secondary turns).

For normal operating, transformer set and reset must be balanced. It can be shown by ∫vdt=0. That is Vg*DTs−(Vo*np/ns)*D′Ts=0
D is duty cycle. D=Ton/Ts.
Ts is the switching period.
   D′=1−D.

| | |
|---|---|
| So Vo = Vg*D*ns/(D′*np) | (3.1) |
| Vop is defined as the output voltage reflected to | |
| primary during Q1 off time, | |
| Vop = (np/ns)*(Vo + ΔV) | (3.2) |
| ΔV represents the voltage drop across diode and trace. | |
| Vg = \sqrt{²}*Vinrms*sin(ωt) | (3.3) |
| Usually, ΔV is small enough compared with Vo. | |
| Vop ≈ (np/ns)*Vo | (3.4) |
| From (3.1) and (3.4), we know Vop = Vg*D/D′ | (3.5) |
| Vop = Vg*D/(1 − D) derive 1 − D = (Vg/Vop)*D | (3.6) |
| D = 1/(1 + Vg/Vop) | (3.7) |
| Substitute Vg, we get D(t) = 1/(1 + | (3.8) |
| \sqrt{²}*Vinrms*sin(ωt)/(np*Vo/ns)) | |

From (3.8), for a predetermined constant DC value Vo, we can adjust duty cycle D(t) according to value of input voltage to guarantee the output voltage constant. Thus the converter converters a 120 Hz or 100 Hz DC sinusoidal waveform to a DC constant voltage.

Dimming can be realized by adjust potentiometer. In FIG. 12, potentiometer R15,R6 and R12 form a voltage divider. During Q1 off, Auxiliary winding ‘•’ end is positive with respect to no ‘•’ end, so does secondary winding. The output voltage Vo is coupled to auxiliary winding for D20 is on. Voltage on top of R6 equals to N2*Vo. (N2 is turns ratio of auxiliary winding and transformer secondary winding. N2=Na/Ns, Na: auxiliary winding turns, Ns: secondary winding turns). So voltage Vs sensed on R12 is N2*Vo*R12/(R12+R15+R6). Vs is compared with interior reference voltage Vr by CMP. If Vs greater than Vr, that show Vo is greater than predetermined value, so duty cycle decreases or fs changes, Vo is decreased until Vo equals to predetermined value; If Vs less than Vr, that shows Vo is less than predetermined value, so duty cycle increases or fs changes, Vo is increased until Vo equals to predetermined value.

So Vs=Vr=N2*Vo*R12/(R12+R15+R6) for steady state. Vr is constant and N2 is constant.
So Vo=Vr*(R12+R15+R6)/(R12*N2). (3.9)
We can adjust potentiometer R15 to change value of (R12+R15+R6)/R12=1+(R15+R6)/R12 to change predetermined Vo. Increase R15, Vo increase; decreases R15, Vo decrease. Thus lamp can be dimmed by change R15 to set output voltage and it is stable with constant voltage. R6 can be potentiometer, then increase R6 to increase Vo, Vice versa. R12 can be potentiometer, we can decrease R12 resistance to increase output voltage or increase R12 resistance to decrease output voltage. Dimming voltage is also DC constant voltage. There is no low frequency component. So the eyes will not feel fatigue due to the low frequency flicker. There is no high frequency light. No EMI issue or no retina harm by peak brightness because eyes pupil can't keep pace with high frequency light. Thus eyes are protected to maximum extent to avoid myopia or retina harm.

Sometimes opto-coupler is used as isolated feedback. In FIG. 13, dimming is realized by changing potentiometer R21 to change feeback signal on Vsense pin to dim voltage. Increase R21 will decrease opto-diode current, then voltage on Vsense pin increases. Controller decreases duty cycle or change frequency to decrease output voltage; Decrease R21 will increase opto-diode current, then voltage on Vsense pin decreases. Controller increases duty cycle or change frequency to increase output voltage. R22 can be potentiometer too. It behaves similar to R21.

In FIG. 14, dimming is realized by changing potentiometer R23. Optocoupler current Ioc=Vref*(R22+R23)/R23/R21=Vref*(1+R22/R23)/R21; Vsense=Vref−Ioc*R12. Output voltage is set by reference voltage times (1+R22/R23). Increase R23, Vo decreases; Vice versa. Vo has small ΔVo increase, Ioc has small increase, Vsense has small decrease. Vo+ΔV has small decreases until equals to Vo.

In one implementation, PFC (power factor correction) can be realized by modulating the average input current ipr(t)av in phase with the input line voltage Vin(t). Thus power factor is unity. PFC also can be done by multiplier, μPFC as in IR1150S or DSP.

Please see FIG. 14, the input current waveform with input voltage through switching Mosfet

| | |
|---|---|
| Slope = \sqrt{²}*Vinrmssin(ωt)/Lm | (3.10) |
| Ipeak = Slope*d(t)*Ts | (3.11) |
| Ipr(t)av = ipeak*d(t)*Ts/2/Ts | (3.12) |
| So we get ipr(t)av = | (3.13) |
| (\sqrt{²}*Vinrmssin(wt)/(2Lm))*d(t)*d(t)*Ts(t) | |
| Let k = d(t)*d(t)*Ts(t), ipr(t)av = | (3.14) |
| (\sqrt{²}*Vinrmssin(wt)/(2Lm)*k | |

We know the input current is in phase with the AC line if k is constant. The converter accomplishes by modulating the average input current iin(t) in phase with the input line voltage Vin(t). Thus the power factor is very near to unity no matter in normal operation or dimming.

Active startup circuit is used to start up the circuit. In other implementation, Active startup circuit can be realized by other way or removed. In other circuit, active startup circuit can have more or less component than FIG. 20,21 or 22.

FIG. 20 shows active startup circuit. ASU pin is designed to drive the Mosfet of the active startup circuit. An external zener diode is to clamp the ASU pin.

Before startup, ASU is floating. Once a voltage is supplied to Vg(t) (DC sinusoidal voltage after bridge rectifier like FIG. 9). The gate capacitor C31 starts to charge via the startup resistor R31. When Vcc reaches the threshold voltage of Q2, transistor Q2 conducts. (Q2 can be NPN transistor or N channel Mosfet). The startup capacitor C32 starts to be charged via the charge resistor R32 and R33 (R32 can be removed). When Vcc reaches the startup threshold voltage, PWM (IW2202) starts operating. Converter main switch Q1 switches and auxiliary winding has voltage coupled from secondary output. ASU goes lower than secondary coupled voltage, thus turns off Q2. Vcc is supplied from C32 that is charged by auxiliary winding and D4.

Thus, supply voltage for PWM (IW2202) no longer uses linear regulator Q2 and the efficiency is improved. FIG. 23 Startup Timing Diagram on pins of IC controller shows that. By select auxiliary winding and secondary winding turns ratio carefully, we guarantee the voltage on the auxiliary winding during minimum dimming is larger than Vcc threshold+Voltage drop on D4; We guarantee the voltage on the auxiliary winding during normal operating is not high enough to damage R33 and Z2. Thus, we can guarantee PWM (IW2202) works well no matter in normal operation or dimming.

In FIG. 12, AC Power line functions as 210 in FIG. 7

In FIG. 12, F1 is a fuse to prevent too much current drawn from power line.(function as RF1201 in FIG. 7) If the current through F1 is larger than its rating current, it melts and open the circuit.

L1, C1 and C2 become a II filter and EMI filter to prevent high frequency component enter line. (function as Filter 202 in FIG. 7)

BR is a full bridge rectifier to rectify AC sinusoidal voltage (FIG. 8) to DC sinusoidal voltage (FIG. 9). (Functions as rectifier 203 in FIG. 7). BR can be realized by other circuit as in FIG. 27,28 or 29.

Q1, T1, D20 compose a flyback power converter. (function as Converter 206 in FIG. 7) C20 is to eliminate high frequency noise.

Halogen lamp is parallel with C20. (function as Lamp 211 in FIG. 7) Auxiliary winding (functions as Sample 207 in FIG. 7) and D4,Q3,D5 supply voltage to PWM and connect to Vcc pin. (Pin1-Vcc is power supply for the controller).

R6, R12 and Potentiometer R15 compose a voltage divider and connect to pin2-Vsense. (function as Feedback and dimmer 205 in FIG. 7) ( Vsense senses signal input from auxiliary winding. This provides the secondary feedback used for output regulation).

Active startup circuit is shown in FIG. 20,21,22. (functions as Active Startup circuit 208 in FIG. 7). Other circuit such as valley-filled, linear regulator can replace circuit as FIG. 20,21,22.

Controller use IW2202 (function as 209 in FIG. 7).

Pin3-SCL is secondary current-limit feedback input. It is pulled up to Vrega through a 10 kohm resistor when secondary current limit function is not used.

Pin4-ASU is gate drive for the external Mosfet in the active start-up circuit. Similar to FIG. 22.

Scaled voltage from line by voltage divider R3, R4 and filter R5, C4 is sent to pin 5-Vindc.

(Sense signal input representing the average line voltage for line regulation, under voltage and over voltage protection.).

Scaled voltage from line by voltage divider R1, R2 is sent to pin 6-Vinac (sense signal input representing AC line voltage.) that is for input current shaping.

R13 and C5 are connected to pin7-Vref (2.0v reference voltage output).

Pin 8-AGND (Analog ground) is grounded.

Pin9-SD (shut down pin. The input signal on SD is sampled during every switching cycle. When the voltage is above the shutdown threshold, the converter goes in a latched shutdown mode). SD can be used as OVP and OTP.

The voltage on R9 is sent to Pin 10-Isense (Primary power switch current limit. This is used to provide cycle-by-cycle current limit). It is used as current limit or over current protection.

C7 is connected to Pin 11-Vrega (Analog regulator output. The internal 3.3v regulator is used for internal analog circuits.)

C6 is connected to Pin 12-Vregd (Digital regulator decoupling pin. Internal 3.3v regulator is used for internal digital circuits.)

Pin 13-PGND is power ground and is grounded.

Pin 14-Output is gate drive signal for the external Mosfet switch. CY1 is a Y cap between primary and secondary ground.

We can also use FIG. 13 to realize similar function. The only difference is the dimming is realized in secondary with opto-coupler. In FIG. 13, R21 is a potentiometer and can be adjusted to set the current in diode of opto-coupler. Suppose current transfer ratio of opto-coupler is CTR. Vsense=Vref−(Vo*CTR*R12)/(R21+R22),

so we get Vo=(Vref−Vsense)*(R21+R22)/(CTR*R12). All other values except R21 are fixed. R21 is a potentiometer that can be adjusted to adjust output voltage Vo. If we want to dim down lamp, we just need to decrease R21 value, vice versa. Of Course we can select R22 as potentiometer. We can add components or delete component on FIG. 13.

In real application, components can be more or less than FIG. 12,13,14. Component value can be different from FIG. 12,13,14. Topology or component connection way may be different from FIG. 12,13,14.

Other controllers with PFC function can be used in power supply with PFC based on Flyback converter. Components, connection way or components value may be different from FIG. 12,13 or 14 etc.

### I-1.2 Power Supply without PFC Based on Flyback Converter

### (In One Implementation, IW2210 is Used as Controller)

In one implementation, AC to constant DC power supply without PFC for Lamp can be realized with IW2210 as in FIG. 15,16,17;

Full bridge rectifier D1˜D4 rectify AC sinusoidal input line voltage (shown in FIG. 8) to DC sinusoidal voltage (shown in FIG. 9). Full bridge rectifier D1˜D4 functions as Rectifier 203 in FIG. 7; Filter can be other circuit.

C1 is a filter to pass high frequency component caused by switching to avoid EMI on line voltage. C1 functions as Filter 202 in FIG. 7;

R3 connect between line voltage and Vcc to startup the controller IW2210, after it operates, Auxiliary winding will charge C3 through D5. This functions as Active Startup Circuit 208 in FIG. 7; Vcc: power supply for the controller IW2210.

Transformer T1, D8, C4 and Q1 compose flyback topology. That works as One Stage DC Sinusoidal to DC Constant Converter 206 in FIG. 7

IW2210 works as controller 209 in FIG. 7;

Output voltage can be coupled to primary through auxiliary winding and connect to Vsense pin by voltage divider composed of R9, R10 and R11. Vsense: Sense signal input from auxiliary winding. This provides the secondary voltage feedback used for output regulation.

Auxiliary winding works as Sample 207 in FIG. 7.

Voltage divider R9, R10 and R11 works as Feedback and dimmer 205 in FIG. 7. R10 is a potentiometer.

R1 and R2 voltage divider connect to Vin pin that is used for line regulation, under voltage and over voltage protection;

Vref is reference voltage output and connected with decoupling capacitor C2 and R4 in parallel;

GND (Analog ground) is grounded;

Isense senses primary switch current to provide cycle-by-cycle current limit.

Output pin output square waveform to switching on/off Main Switch Mosfet Q1.

R6, R7 and R8 become a voltage divider and connect to pin OVP/OTP. When output voltage is higher than a threshold, the voltage coupled on OVP/OTP pin through auxiliary winding will reach a threshold of interior controller, it shuts down. So it functions as OVP. It can also function as OTP. For example, if R8 is a thermistor and changes to a very high value during high temperature, then the voltage on pin OVP/OTP can reach threshold and shuts down controller. Any of R6, R7 or R8 can be a thermistor, thermal resistor; NTC (negative temperature coefficient) or PTC (positive temperature coefficient) depends on the OTP function requirement;

During the period when Q1 is on (0<t<=DTs), the ‘•’ end voltage is negative with respect to no ‘•’ end of both primary and secondary transformer windings, thus diode D3 could not turn on. Energy is saved in the magnetic inductance Lm. The voltage cross primary winding is Vg. (Vg is DC sinusoidal voltage as FIG. 9 after AC voltage rectified). During the period when Q1 is off (DTs<=t<Ts), the polarity of the transformer winding changes. ‘•’ end voltage is positive with respect to no ‘•’ end for both primary and secondary windings of transformer. Thus D3 turns on and energy is delivered to the output. The voltage cross primary winding is Vo*n. (Vo is output DC voltage and n is transformer turns ratio n=np/ns, np is primary turns; ns is secondary turns). The voltage coupled cross auxiliary winding is Vo*Na/Ns. Voltage on Vsense=(Vo*Na/Ns)*R11/(R9+R10+R11).

As shown in FIG. 18, if the auxiliary voltage is higher than the threshold set by the reference at tn, the next pulse the controller generates is a sense pulse. This is a much shorter pulse. The frequency of the operation is kept constant pulse by pulse, which result in discontinuous operation during sense cycles.

As shown in FIG. 18, if the auxiliary voltage at tn+1 is below the threshold, the next pulse is a power pulse.

If the voltage is still too high, the controller sends more sense pulses. If the feedback voltage is still too high after 12 sense pulse, the converter transitions into SmartSkip mode operation, sending out very narrow skip pulses and gradually decreasing the operating frequency until the generated power is in balance with the load. The minimum operating period at no load is about 2 ms.

Thus the feedback guarantees the output voltage is constant at predetermined value. Vsense=(Vo*Na/Ns)*R11/(R9+R10+R11)=Vinterior ref.(Vinterior ref is interior reference voltage).
Vo=Vinterior ref*(Ns/Na)*(1+(R9+R10)/R11).

In one implementation, R10 is a potentiometer. So decrease R10 value to decrease Vo to realize dimming with feedback. R9 or R11 can be a potentiometer, then decrease R9 or increase R11 value to decrease Vo to realize dimming.

In one implementation, Controller 209 is IW2210 that uses Pulse Train control algorithm, which is a discrete time bang-bang type control that provides ultra-fast transient response, and guarantees loop stability without external loop compensation components. The controller provides three types of pulses to output driver, depending on the real-time value of the output voltage. (1) If output voltage Vo is too low, the controller sends out a power pulse that is high-energy pulses that transfer enough energy to the output to provide up to 130% of the rated output power for the converter; (2) If the output voltage Vo is too high, the controller sends out a sense pulse which represents significantly less energy than the power pulses. While in regulation, the controller adjusts the average mix of power and sense pulses to balance the energy provided by the converter and used by the load, thus regulating the output voltage within its specified limits. (3) If the load is very light, the controller operates in Smart Skip mode which generates ultra-narrow skip pulses and gradually reduces the frequency to keep the output in regulation down to zero load current.

FIG. 18 shows the Vsense waveform over four switching cycles. The voltage feedback block and the digital controller make a cycle-by-cycle determination of the type of pulse that will be generated in the next switching cycle. The first cycle shown is a power pulse. It is sampled close to the edge of the “flat portion” of the waveform, before the flux in the transformer collapses and the Vsense voltage falls. This time point is labeled tn. The controller turns on the switch again at the first minimum point of the auxiliary voltage. This point is calculated by the digital controller based on input from the Zero Voltage Detector block. This operation corresponds to valley-mode voltage switching (VMS) on the main power switch. VMS minimizes switching losses and increases the efficiency of the converter. The controller operates in critical discontinuous mode during power cycles. This operation maximizes the power density of the magnetic and minimizes its size for a given power level. If the auxiliary voltage is higher than the threshold set by the reference at tn, the next pulse the controller generates is a sense pulse. This is a much shorter pulse. The frequency of the operation is kept constant pulse by pulse, which results in discontinuous operation during sense cycles. If the auxiliary voltages at tn+1 is below the threshold, the next pulse is a power pulse, as shown in FIG. 18. However, if the voltage is still too high, the controller sends more sense pulses. If the feedback voltage is still too high after 12 sense pulses, the converter transitions into SmartSkiptm mode operation, sending out very narrow skip pulses and gradually decreasing the operating frequency until the generated power is in balance with the load. The minimum operating period at no load is about 2 ms.

We can also use FIG. 16 to realize similar function. The only difference is the dimming is realized in secondary with opto-coupler. In FIG. 16, R21 is a potentiometer and can be adjusted to set the current in diode of opto-coupler. Suppose current transfer ratio of opto-coupler is CTR. Vsense=Vref−(Vo*CTR*R10)/(R21+R20),

so we get Vo=(Vref−Vsense)*(R21+R20)/(CTR*R10). All other values except R21 are fixed. R21 is a potentiometer that can be adjusted to adjust output voltage Vo. If we want to dim down lamp, we just need to decrease R21 value, vice versa. Of Course we can select R20 as potentiometer then we can decrease R20 value to realize dimming.

In FIG. 17, dimming is realized by changing potentiometer R22. Optocoupler current Ioc=Vref*(R22+R23)/R23/R20=Vref*(1+R22/R23)/R20; Vsense=Vicref−Ioc*R10 Output voltage is set by reference voltage times (1+R22/R23). Decrease R22, Vo decreases; Vice versa. Vo has small ΔVo increase, Ioc has small increase, Vsense has small decrease. Vo+ΔV has small decreases until equals to Vo. Feedback guarantees the voltage in regulation. R23 can be a potentiometer, increase R23 to decrease Vo to realize dimming.

In real application, component can be more or less than FIG. 15,16,17. Component value can be different from FIG. 15,16,17. Topology or component connection way may be different from FIG. 15,16,17.

Other controllers without PFC function can be used in power supply without PFC based on Flyback converter (such as Iw1688). Components, connection way or components value may be different from FIG. 15,16 or 17 etc. For example, UCC28600 is used with schematic as FIG. 24 and the function is similar to FIG. 17. In real application, components or values or connection way may be different from FIG. 24.

### I-1.3 Power Supply Based on Flyback Converter with Switch Integrated in Controller

### (In One Implementation, LNK362-364 is Used as Controller with Switch Integrated)

FIG. 25 is the schematic in one implementation.

The AC input is rectified by D1 to D4 (as Rectifier block 203 in schematic 7) and filtered by the bulk storage capacitors C1 and C2.

Resistor RF1 is a fuse, PTC or NTC thermistor, or inrush current limiter or other over current protection. (As RF1 block 201 in schematic 7).

Together with the π filter formed by C1, C2, L1 and L2, differential mode noise attenuator. (as Filter block 202 in schematic 7) Other type of filter can also be used here.

Resistor R1 damps ringing caused by L1 and L2.

The rectified and filtered input voltage is applied to the primary winding of T1.

The other side of the primary is driven by the integrated MOSFET in U1. The secondary of the flyback transformer T1 is rectified by D5, and filtered by C4. (All these are as block 204 in schematic 7). U1,T1,D5,C4 compose a flyback converter as 206 in FIG. 7.

The combined voltage drop across VR1, R4, R5 and the LED of U2 determines the output voltage. R4 and R5 are as Sample block 207 in schematic 7.

VR1, R2, R3, U2, R4, R5 and C3 are Feedback and Dimmer block 205 in schematic 7.

Suppose VR1 rating voltage=Vzener. Vr2 is voltage across resistor R2. Vu2led is voltage across LED in opto-coupler U2.
Vo=[Vzener+Vr2+Vu2led]*(R4+R5)/R5=[Vzener+Vr2+Vu2led]*(1+R4/R5)
Vr2<<Vzener, VU2LED<<Vzener, So Vo≈Vzener*(1+R4/R5)

We can increase R5 to decrease Vo to realize dimming. If R4 is a potentiometer, we can decrease R4 to decrease Vo for dimming.

In one implementation, when the output voltage exceeds this level, current will flow through the LED of U2. As the LED current increases, the current fed into the FEEDBACK pin of U1 increases until the turnoff threshold current is reached, disabling further switching cycles, and at very light loads, almost all the switching cycles will be disabled, giving a low effective frequency and providing high light load efficiency and low no-load consumption. Resistor R2 provides 1 mA through VR1 to bias the Zener closer to its test current. Resistor R3 allows the output voltage to be adjusted to compensate for designs where the value of the zener may not be ideal, as they are only available in discrete voltage ratings. For higher output accuracy, the Zener may be replaced with a reference IC such as the TL431. The LinkSwitch-XT is completely self-powered from the DRAIN pin, requiring only a small ceramic capacitor C3 connected to the BYPASS pin. No auxiliary winding on the transformer is required.

Several implementations are listed in FIG. 25. Feedback can use opto-coupler as shown in first schematic in FIG. 25; Feedback can use auxiliary winding as shown in second schematic in FIG. 25; Feedback can directly comes from secondary voltage divider as third schematic in FIG. 25.

In real application, component can be more or less than FIG. 25. Component value can be different from FIG. 25. Topology or component connection way may be different from FIG. 25.

Other controllers with switch integrated into the controller can also be used in power supply based on Flyback converter with switch integrated in controller.

As above part1, power supply for lamp can be realized by flyback converter with or without PFC and can use all kinds of controllers with any kind of control method or algorithm for controller 209 in FIG. 7.

### I-2 Part 2. Other Topology Converter Used As Converter 206

### I-2.1 Power Supply Based on Full-bridge Converter (FIG. 44)

Vo=(n2/n1)*D*Vg,
Vo: output voltage; n1: primary winding turns; n2: secondary winding turns;
D: duty cycle; Vg: input voltage

Any Full-bridge controller with any control way that can convert DC sinusoidal voltage to DC constant voltage can be used as controller 209.

### I-2.2 Power Supply Based on Half-bridge Converter (FIG. 45)

Vo=0.5*(n2/n1)*D*Vg,
Vo: output voltage; n1: primary winding turns; n2: secondary winding turns;
D: duty cycle; Vg: input voltage

Any Half-bridge controller with any control way that can convert DC sinusoidal voltage to DC constant voltage can be used as controller 209.

### I-2.3 Power Supply Based on Forward Converter (FIG. 46)

Vo=(n3/n1)*D*Vg,
Vo: output voltage; n3: secondary winding turns; n1: primary winding turns;
D: duty cycle; Vg: input voltage

Any Forward controller with any control way that can convert DC sinusoidal voltage to DC constant voltage can be used as controller 209.

### I-2.4 Power Supply Based on Two-transistor Forward Converter (FIG. 47)

Vo=(n2/n1)*D*Vg,
Vo: output voltage; n1 :primary winding turns; n2: secondary winding turns;
D: duty cycle; Vg: input voltage

Any two-transistor Forward controller with any control way that can convert DC sinusoidal voltage to DC constant voltage can be used as controller 209.

### I-2.5 Power Supply Based on Push-pull Converter (FIG. 48)

Vo=(n2/n1)*D*Vg,
Vo: output voltage; n1: primary winding turns; n2: secondary winding turns;
D: duty cycle; Vg: input voltage

Any two-transistor Forward controller with any control way that can convert DC sinusoidal voltage to DC constant voltage can be used as controller 209.

### I-2.6 Power Supply Based on Push-pull Converter Based on Watkins-Johnson Converter

(FIG. 49)
Vo=(n2/n1)*(2D−1)Vg/D,
Vo: output voltage; n1: primary winding turns; n2: secondary winding turns;
D: duty cycle; Vg: input voltage

Any Push-pull converter based on Watkins-Johnson controller with any control way that can convert DC sinusoidal voltage to DC constant voltage can be used as controller 209.

### I-2.7 Power Supply Based on Isolated SEPIC Converter (FIG. 50)

Vo=(n2/n1)*D*Vg/D′,
Vo: output voltage; n1: primary winding turns; n2: secondary winding turns;
D: duty cycle; D′=1−D; Vg: input voltage

Any Isolated SEPIC controller with any control way that can convert DC sinusoidal voltage to DC constant voltage can be used as controller 209.

### I-2.8 Power Supply Based on Isolated Inverse SEPIC Converter (FIG. 51)

Vo=(n2/n1)*D*Vg/D′,
Vo: output voltage; n1: primary winding turns; n2: secondary winding turns;
D: duty cycle; D′=1−D; Vg: input voltage

Any Isolated Inverse SEPIC controller with any control way that can convert DC sinusoidal voltage to DC constant voltage can be used as controller 209.

### I-2.9 Power Supply Based on Isolated Cuk Converter (FIG. 52)

Vo=(n2/n1)*D*Vg/D′,
Vo: output voltage; n1: primary winding turns; n2: secondary winding turns;
D: duty cycle; D′=1−D; Vg: input voltage

Any Cuk controller with any control way that can convert DC sinusoidal voltage to DC constant voltage can be used as controller 209.

### I-2.10 Power Supply Based on Two-transistor Flyback Converter (FIG. 53)

Vo=Vg*D*(n2/n1)/D′
Vo: output voltage; n1: primary winding turns; n2: secondary winding turns;
D: duty cycle; D′=1−D; Vg: input voltage

Any Two-transistor flyback controller with any control way that can convert DC sinusoidal voltage to DC constant voltage can be used as controller 209.

As above, components can be more or less than FIG. 44 to FIG. 53. Other isolated topologies also can be used here. Any controller with any control way that can convert DC sinusoidal voltage to DC constant voltage can be used as controller 209.

### Type II. Non-Isolated Converter

### II-1 Part 1. Buck Converter Used As Converter 206

Buck converter is shown in FIG. 26. The function is described as the following:

Transistor Q1 on, 0<t<DTs, voltage on point A equals to Vg, diode D1 is off, voltage on point A is positive with respect to point B on inductor L1, VA=Vg;

Transistor Q1 off, DTs<t<Ts, polarity of inductor change, voltage on point A is negative with respect to point B on inductor L1, diode D1 turns on, VA=0.

Output voltage is average value of VA for the filter composed of L1, C1. So Vo=(Vg*DTs+0*D′Ts)/Ts=DVg.

### II-1.1 Power Supply Based on Buck Converter with Switch Integrated in Controller

### (In One Implementation, LNK302/304-306 is Used as Controller)

The circuits shown in FIG. 27,28,29 are typical implementations of non-isolated power supply.

The input stage comprises fusible resistor RF1 (as RF1 201 block in FIG. 7); Resistor RF1 is a flame proof, fusible, wire wound resistor. It accomplishes several functions:
a) Inrush current limitation to safe levels for rectifiers D3 and D4;
b) Differential mode noise attenuation;
c) Input fuse should blow up when any other component fail for short circuit

Diodes D3 and D4 work as Rectifier 203 in FIG. 7;

Capacitors C4 and C5, and inductor L2 (as Filter block 202 in FIG. 7).

The power processing stage is formed by the LinkSwitch-TN, freewheeling diode D1, Controller U1, output choke L1, and the output capacitor C2 compose Buck converter (as converter 206 in FIG. 7)

The LNK302/304-306 was selected for U1 as controller 209 in FIG. 7 such that the power supply operates in the mostly discontinuous-mode (MDCM). Diode D1 is an ultra-fast diode with a reverse recovery time (trr) of approximately 75 ns, acceptable for MDCM operation. For continuous conduction mode (CCM) designs, a diode with a reverse recovery time less than 35 ns is recommended. Inductor L1 is a standard off-the-shelf inductor with appropriate RMS current rating (and acceptable temperature rise). Capacitor C2 is the output filter capacitor; its primary function is to limit the output voltage ripple.

(controller U1 with switch integrated into, diode D1, inductor L1 and capacitor C2 become a buck converter as block 204 in schematic 7)

Active startup circuit 208 and main switch are integrated in IC controller U1.

To a first order, the forward voltage drops of D1 and D2 are identical. Therefore, the voltage across C3 tracks the output voltage. The voltage developed across C3 is sensed and regulated via the resistor divider R1 and R3 (R1 or R3 is a potentiometer) connected to U1's FB pin. The values of R1 and R3 are selected such that, at the desired output voltage, the voltage at the FB pin is 1.65v. So Vout·R3/(R1+R3)=1.65v, Vout=1.65*(1+R1/R3).

If R3 is a potentiometer, we can increase R3 to decrease output voltage for dimming;

If R1 is a potentiometer, we can decrease R1 to decrease output voltage for dimming.

Main switch is integrated in IC LNK302/304-306.

D2, become sample block 207 in FIG. 7;

C3, R1, R3 work as Feedback and dimmer block 205 in FIG. 7.

In one implementation, Regulation is maintained by skipping switching cycles. As the output voltage rises, the current into the FB pin will rise. If this exceeds Ifb then subsequent cycles will be skipped until the current reduces below Ifb. Thus, as the output load is reduced, more cycles will be skipped and if the load increases, fewer cycles are skipped. To provide overload protection if no cycles are skipped during a 50 ms period, LinkSwitch-TN will enter auto-restart (LNK304-306), limiting the average output power to approximately 6% of the maximum overload power. Due to tracking errors between the output voltage and the voltage across C3 at light load or no load, a small pre-load may be required (R4). For the design in FIG. 27, if regulation to zero load is required, then this value should be reduced to 2.4 kohm.

Feedback can be realized by opto-coupler as in FIG. 28 or FIG. 29.

Output voltage is set by voltage divider composed of potentiometer R3 and resistor R1. Voltage of reference Z1 is Vz. Vo=Vz*(1+R1/R3). Dimming can be realized by increasing R3. If R1 is potentiometer, dimming can be realized by decreasing R1 value.

Connection or component values can be changed in application. Components can be more or less than FIG. 27,28,29.

As above in Part 2, we can use any buck controller with any kind of control way or algorithm which can convert DC sinusoidal voltage to DC constant voltage with switch or without switch integrated in power supply for lamp with PFC or without PFC.

### II-2 Part 2. Buck-Boost Converter Used As Converter 206

Buck-Boost converter is shown in FIG. 30. The function is described as the following:

Transistor Q1 on, 0<t<DTs, voltage across L1 equals to Vg, diode D1 is off, voltage on point A is positive with respect to point B on inductor L1, VA=Vg;

Transistor Q1 off, DTs<t<Ts, polarity of inductor change, voltage on point A is negative with respect to point B on inductor L1, diode D1 turns on, VL=−Vo.

For steady state, the average of voltage across inductor L1 should be 0. So 0=(Vg*DTs+Vo*D′Ts)/Ts; Vo=−Vg*D/D′, Vo had opposite polarity as Vg.

### II-2.1 Power Supply Based on Buck-Boost Converter with Switch Integrated in Controller

### (In One Implementation, LNK302/304-306 is Used As Controller)

The circuits shown in FIG. 31,32,33 are typical implementations of non-isolated power supply. Regulation and feedback is already described in II-2.

Feedback can be realized by opto-coupler as in FIG. 33.

Output voltage is set by voltage divider composed of potentiometer R3 and resistor R1. Voltage of reference Z1 is Vz. Vo=Vz*(1+R1/R3). Dimming can be realized by increasing R3. If R1 is potentiometer, dimming can be realized by decreasing R1 value.

Connection or component values can be changed in application. Components can be more or less than FIG. 31,32,33.

As above in II-2 Part 2, we can use any buck-boost controller with any kind of control way or algorithm which can convert DC sinusoidal voltage to DC constant voltage with switch or without switch integrated in power supply for lamp.

### II-3 Part 3. Other Non-isolated Topology Converter Used As Converter 206

### II-3.1 Power Supply Based on Boost Converter (FIG. 34)

Vo=Vg/D′,
Vo: output voltage; D: duty cycle; D′=1−D; Vg: input voltage

Any Boost controller with any control way that can convert DC sinusoidal voltage to DC constant voltage can be used as controller 209.

### II-3.2 Power Supply Based on Noninverting Buck-Boost Converter (FIG. 35)

Vo=Vg*D/D′,
Vo: output voltage; D: duty cycle; D′=1−D; Vg: input voltage

Any noninverting Buck-Boost controller with any control way that can convert DC sinusoidal voltage to DC constant voltage can be used as controller 209.

### II-3.3 Power Supply Based on H-Bridge Converter (FIG. 36)

Vo=Vg*(2D−1),
Vo: output voltage; D: duty cycle; Vg: input voltage

Any H-bridge controller with any control way that can convert DC sinusoidal voltage to DC constant voltage can be used as controller 209.

### II-3.4 Power Supply Based on Watkins-Johnson Converter (FIG. 37)

Vo=Vg*(2D−1)/D,
Vo: output voltage; D: duty cycle; Vg: input voltage

Any Watkins-Johnson controller with any control way that can convert DC sinusoidal voltage to DC constant voltage can be used as controller 209.

### II-3.5 Power Supply Based on Current-fed Bridge Converter (FIG. 38)

Vo=Vg/(2D−1),
Vo: output voltage; D: duty cycle; Vg: input voltage

Any current-fed bridge controller with any control way that can convert DC sinusoidal voltage to DC constant voltage can be used as controller 209.

### II-3.6 Power Supply Based on Inverse of Watkins-Johnson Converter (FIG. 39)

Vo=Vg*D/(2D−1),
Vo: output voltage; D: duty cycle; Vg: input voltage

Any Inverse of Watkins-Johnson controller with any control way that can convert DC sinusoidal voltage to DC constant voltage can be used as controller 209.

### II-3.7 Power Supply Based on Cuk Converter (FIG. 40)

Vo=−Vg*D/D′,
Vo: output voltage; D: duty cycle; D′=1−D; Vg: input voltage

Any Cuk controller with any control way that can convert DC sinusoidal voltage to DC constant voltage can be used as controller 209.

### II-3.8 Power Supply Based on SEPIC Converter (FIG. 41)

Vo=Vg*D/D′,
Vo: output voltage; D: duty cycle; D′=1−D; Vg: input voltage

Any SEPIC controller with any control way that can convert DC sinusoidal voltage to DC constant voltage can be used as controller 209.

### II-3.9 Power Supply Based on Inverse of SEPIC Converter (FIG. 42)

Vo=Vg*D/D′,
Vo: output voltage; D: duty cycle; D′=1D; Vg: input voltage

Any Inverse of SEPIC controller with any control way that can convert DC sinusoidal voltage to DC constant voltage can be used as controller 209.

### II-3.10 Power Supply Based on Buck Square Converter (FIG. 43)

VO=D*D
Vo: output voltage; D: duty cycle; Vg: input voltage

Any Buck square controller with any control way that can convert DC sinusoidal voltage to DC constant voltage can be used as controller 209.

Other non-isolated topology controller with any control which can convert DC sinusoidal voltage to DC constant voltage can also be used as controller 209.

Controller 209 can use all kinds of control method such as digital control, analog control, DSP, SmartSkip Mode, LinkSwitch-XT or LinkSwtich-TN mode etc.

A number of implementations have been described. Nevertheless, it will be understood that various modifications may be made without departing from the spirit and scope of the invention. Moreover, the converter topologies discussed above can be used within power supplies to supply power to devices other than lamps—For example, Bus AC to DC converter, PFC converter, PFC converter for lighting,Computer power supply, Monitor power supply, notebook adapter, LCD TV, AC/DC adapter, Adjusted output voltage Battery charger, Power tool charger, Electronic ballast, Video game power supply.

What is claimed is:

1. A power supply operable to convert AC sinusoidal voltage in wide range voltage (input voltage) into a constant DC voltage having a predetermined value with Feedback with PFC function or without PFC function.
The DC voltage value can be lower than input AC peak voltage or higher than input AC peak voltage or equal to input AC peak voltage.
Normal operating without dimming, Vout=rating voltage of lamp;
Dimming operating, Vout=dimming voltage set by potentiometer.
Feedback signal is fed from voltage divider of secondary output voltage to feedback pin of controller 209 as in FIG. 7 or the feedback signal can be coupled to primary from secondary or secondary output voltage divider by opto-coupler, signal transformer, auxiliary winding or digital isolator IC etc and then send to feedback pin of controller 209 as in FIG. 7.
Potentiometer (rheostat) voltage divider functions as dimming function and set dimming level.
The power supply of claim 1 has one stage converter operable to transfer DC sinusoidal voltage into a DC constant voltage at predetermined value.
Before, two stages of converters were applied to realize same function as power supply of claim 1, especially when converting a high input AC sinusoidal line voltage to a low DC constant voltage less than peak input voltage of AC line.
The first stage is a boost AC to DC converter that can only convert an Ac input line voltage to a DC constant voltage higher than or equal to input peak voltage of AC line. Boost converter can have PFC or have no PFC function.
The second stage is a DC-to-DC converter that can convert a high DC voltage to a low DC voltage.
Traditional two stage circuits have higher cost and lower efficiency. So the power supply of claim 1 saves the cost and increases the efficiency to maximum extent.

2. Power supply of claim 1 can be applied directly on second category lamp. Lamps have two categories:
First category uses ballast to strike the lamp to start. Most of them use gas to create light such as Fluorescent, HID, Compact, metal halide lamp etc. Bulbs need ballast because they use gas to create light. When the gas is excited by electricity, it emits invisible ultraviolet light that hits the white coating inside the bulb. The coating changes the ultraviolet light into light you can see. It needs a very high voltage strike to startup the operation of the lamp. But my invention is not applied directly to this category. The invention must be combined with second stage ballast to drive the lamp.
Second category doesn't need ballast to start the lamp. Most of them use heat generated by filament or diode etc to create light. Such as Halogen, Incandescent, LED, PAR lamp, miniature sealed beam lamp, Projection lamp, automotive lamp, some stage and studio lamp, DC fluorescent lamp etc. They can use as Lamp 211.
My patent (power supply of claim 1) can be used directly on second category lamp.

3. Power supply of claim 1 has protection to eyesight and people's health to maximum extent for lamp has constant DC level output voltage that does not contain low frequency or high frequency voltage component.
Brightness of lamp is proportional to applied voltage magnitude.
For example, higher voltage causes higher brightness in second category lamp of claim 2 (such as halogen lamp).
60 Hz or 50 Hz sinusoidal voltage applied on lamp will cause lamp brightness to change 60 or 50 times per second because 60 Hz or 50 Hz sinusoidal voltage will change magnitude 60 or 50 times per second.
Low frequency light cause eyes pupil and crystalline lens will adjust 60 times, 120 or many times per second to cause eyes tired. Pupil open wide and crystalline lens adjust to collect more light to focus on retina for seeing clearly at weak light while pupil open narrow and crystalline lens adjust to collect less light to focus on retina at strong light to prevent retina from strong light harm and hurt.
In the long run, muscles to control pupil and crystalline lens become very tired and become flabby. Then the muscle can't adjust pupil and crystalline according to distance and brightness so that myopia is caused.
To relieve eye's tiredness, current technology for fluorescent lamp uses high frequency voltage in a DC envelope. High frequency voltage causes lamp brightness changes too fast. Eyes can not adjust fast enough to follow the brightness change of lamp for high frequency voltage. But high frequency large current on the secondary cause high EMI that has risk to harm people's health.
High frequency light causes EMI issue.
Peoples' eyes can't keep up with high frequency light. Peak strong light shine on the retina for pupil can't shrink at high frequency light. In the long run, retina will be harmed and affect eyesight, cornea dryness or crystalline lens opacity is caused.
On the market, most of filament lamp use power supply that contains 60 Hz or 50 Hz low frequency component; Lamps such as fluorescent that needs high voltage strike use power supply containing high frequency component.
My invention of power supply lamp has only DC constant voltage on lamp. Lamp's brightness is constant and has no low frequency or high frequency component. Thus peoples' eyes and health are protected to maximum extent.

4. The power supply of claim 1 is comprising: (refer to FIG. 7)
In one implementation, power supply 200 includes an RF1 201, an input filter 202, a rectifier 203, a one stage substantially DC sinusoidal to DC constant voltage converter 206, a controller 209, feedback and dimmer circuit 205, sample circuit 207, active startup circuit 208 and lamp 211. Some circuit may have more or less block. In some application, 208 or main switch of 206 can be integrated into IC controller 209. Or other block can be integrated into one IC.
Each block can use all kinds of different circuits with similar function as the following.
An input voltage (210) has AC sinusoidal waveform. It could come from 50 Hz 220VAC or 60 Hz 110VAC etc sinusoidal power system line voltage or other voltage sources (AC or DC);
Input RF1 201 provides input current protection for converter 200. In particular, in one implementation, input fuse is designed to provide current protection for converter 206 by cutting off current flow to converter 206 in an event that current being drawn through input fuse 201 exceeds a predetermined design rating.
In another implementation, RF1 201 is a flameproof, fusible, wire wound type and functions as a fuse, inrush current limiter.
In another implementation, RF1 201 can be a NTC or PTC thermistor. (Negative temperature coefficient thermal resistor or Positive temperature coefficient thermal resistor)
Input filter 202 minimizes an effect of electromagnetic interference (EMI) on power supply 200, converter 206 and exterior power system.
Input filter 202 can be LC filter, π filter, differential mode filter, common mode filter or any type of filter that provides a low impedance path for high-frequency noise to protect power supply 200 and exterior power system from EMI.
Input filter 202 can be placed in front of rectifier 203 or behind rectifier 203.
Rectifier 203 is any type of rectifier that converts the input sinusoidal AC source voltage (like FIG. 8 in one implementation) from voltage source 210 into a substantially DC sinusoidal voltage (like FIG. 9 in one implementation).
In one implementation, rectifier 203 is a full-wave rectifier that includes four rectifiers in a bridge configuration.
In another implementation, rectifier 203 contains 2 diodes as shown in FIG. 29. In another implementation, rectifier 203 can use bridgeless PFC.
One stage DC sinusoidal to constant DC converter 206 converts the substantially DC sinusoidal voltage (like FIG. 9) received from rectifier 203 into a DC constant voltage at predetermined value suitable to support an output device (e.g., halogen lamp 211).
In one implementation, converter 206 converts the substantially DC sinusoidal voltage received from rectifier 203 into DC constant voltage. For example 12 volts (FIG. 10). Usually the input voltage source 210 comes from 60 Hz 110v AC or 50 Hz 220v AC sinusoidal line voltage (FIG. 8) in power system.
Controller 209 is operable to control an output voltage level of converter 206.
In one implementation, controller 209 is operable to adjust the duty cycle, on time of main switch or switching frequency of converter 206 so that converter 206 outputs a DC constant output voltage having a predetermined voltage value.
The controller 209 can use all kinds of method, mode and control to regulate a DC constant voltage at predetermined level. Such as digital control, analogy control, DSP, bang-bang control, skipping switching cycles as in LNK302/304-306, Pulse Train control as in IW2210 etc.
The controller 209 operable to realize PFC function (When using IW2202 controller, it is realized with pins VinAC and VinDC) or without PFC finction; The controller 209 operable to realize current limit protection and short circuit protection (When using IW2202 controller, it is realized with pin Isense;) Of course, controller 209 also can realize such functions as OVP-over voltage protection, OTP-over temperature protection, SCL-Secondary-side current limit) etc.
Controller 209 can also be a linear control type controller, PWM controller or PFC controller etc. Controller 209 can control an output voltage level of converter 206 responsive to a predetermined value set by potentiometer voltage divider. Feedback control voltage comes from feedback and dimmer circuit 205 as discussed in greater detail below.
Sample 207 sense the signal proportional to output DC constant voltage. Such as auxiliary winding, opto-coupler, voltage divider, digital isolator or voltage divider on output etc
Feedback and dimmer circuit 205 is operable to provide a feedback dimming control voltage to controller 209 for dimming (or decreasing) output voltage (e.g., lamp 211) by changing potentiometer value to set predetermined output value (Vset).
When Vout is greater than Vset, Feedback signal on FB pin of controller is compared to interior reference. Then duty cycle, frequency or switch mode etc are changed to decrease output voltage until Vout equals to Vset;
When Vout is lower than Vset, Feedback signal on FB pin of controller is compared to interior reference. Then duty cycle, frequency or switch mode etc are changed to increase output voltage until Vout equals to Vset;
Thus, the output voltage is regulated at set value by Feedback.
Normal operation, the predetermined value Vset is set to lamp rating voltage.
Dimming, the predetermined value Vset is set to lower than lamp rating voltage.
In one implementation, 205 can be realized by a resistor voltage divider composed of potentiometer and resistor (or zenor diode and resistor voltage divider composed of potentiometer and resistor) and voltage across one resistor or secondary is coupled to Feedback pin of controller 209 by opto-coupler, signal transformer, auxiliary winding, digital isolator or voltage divider on output etc). as in FIG. 12,13,14,15,16,17,24,25, 27,28,29,31,32,33 etc
An Active startup circuit 208 is operable to startup the circuit before power supply operates normally. 208 can use different circuits as shown in FIG. 20,21,22 etc or other circuits. Sometimes, it is integrated with controller 209 in one IC.
A lamp 211 can be any lamp without requirement for high voltage strike start as second category lamp in claim 2.
The power supply of claim 1 can contain more blocks or less blocks than blocks shown in FIG. 7. Some blocks can be integrated into one block or some blocks can be integrated into one IC. Block sequence can be changed. The power supply of claim 1 can be realized by discrete components. The power supply of claim 1 can have no external compensation components or have external compensation components.

5. The controller 209 of power supply of claim 1 can have PFC function as in IW2202 etc and no PFC function as in IW2210, iW1688, LNK362-364 and LNK302/304-306 etc.
PFC function guarantees power factor is always almost unity at normal operating or dimming. That is input sinusoidal current is always in phase with input sinusoidal voltage. That will increase power quality for the power system. The power supply of claim 1 realizes green mode efficiency with PFC function.
PFC can be realized by multiplier in controller or by μPFC (Integrator with Reset) such as in IR1150 OR DSP, digital control as in IW2202 or any method.

6. The power supply of claim 1 has dimming and feedback function that keep output voltage at a DC constant value Vo set by potentiometer or signal; Dimming signal can come from wireless controller or power line communication. Feedback can be voltage feedback, current feedback or power feedback etc
(6.1) The power supply of claim 1 with IW2202 as controller 209 is shown in FIG. 12,13,14; In real application, component can be more or less than FIG. 12,13,14. Components code or value maybe different from FIG. 12,13,14. Components connect way can be different from FIG. 12,13,14.
In FIG. 12, the voltage Va coupled on auxiliary winding in sample circuit is proportional to Vo (Va=Vo*Na/Ns Na is turns of auxiliary winding; Ns is turns of secondary winding, Vo is output voltage). Vo is less than or equal to lamp rating voltage. Then a voltage divider get a sample voltage Vsense=Va*Voltage divider ratio (R12/(R12+R15+R6)) and compare Vsense with interior reference voltage Vinterior ref.
If Vo is larger than predetermined value, then Vsense is greater than Vinterior ref, the controller 209 will adjust duty cycle, switching frequency or switch mode of main switch in converter 206 until Vo decreases to predetermined value.
If Vo is less than predetermined value, then Vsense is less than Vinterior ref, the controller 209 will adjust duty cycle, switching frequency or switch mode of main switch in converter 206 until Vo increases to predetermined value. Thus feedback function keeps output Voltage at a predetermined DC constant level.
For steady operation, Vsense=Vinterior ref.
Vsense=Va*(R12/(R12+R15+R6))=Vo*(Na/Ns)*(R12/(R12+R15+R6))
So Vo=Vinterior ref*Ns*(R12+R15+R6)/R12/Na
Vo=Vinterior ref*(Ns/Na)*(1+(R15+R6)/R12).
Knowing Vinterior ref, we can regulate Vo by select value of Ns,Na,R15,R6,R12 etc;
The feedback circuit of claim 1 also finctions as dimming circuit. Any one of R15, R6 or R12 can be a potentiometer (Analog potentiometer or digital potentiometer). We can change the potentiometer value to decrease Vo to realize dimming. For example, R12 is a potentiometer. We can increase R12 to decrease Vo to realize dimming. If R15 or R6 is a potentiometer, we can decrease R15 or R6 resistance to decrease output voltage for dimming at predetermined level.
(6.2) The power supply of claim 1 with IW2210 as controller 209 is shown in FIG. 15,16,17.
In real application, component can be more or less than FIG. 15,16,17 and component value maybe different from components in FIG. 15,16,17. Components connect way can be different from FIG. 15,16,17.
In FIG. 15, the voltage cross primary winding is Vo*n. (Vo is output DC voltage and n is transformer turns ratio n=np/ns, np is primary turns; ns is secondary turns).
The voltage coupled cross auxiliary winding is Vo*Na/Ns. Voltage on
Vsense=(Vo*Na/Ns)*R11/(R9+R10+R11).
Power pulse, sense pulse and Power skip mode keep output voltage constant. The feedback guarantees the output voltage is constant at predetermined value.
Vsense=(Vo*Na/Ns)*R11/(R9+R10+R11)=Vinterior ref.
(Vinterior ref is interior reference voltage).
Vo=Vinterior ref*(Ns/Na)*[(R9+R10)/R 11+1].
In one implementation, R11 is a potentiometer. So increase R11 value to decrease Vo to realize dimming with feedback. If R9 or R10 is a potentiometer, then decrease R9 or R10 value to decrease Vo to realize dimming.
The power supply of claim 1 can realize dimming with LNK302/304˜306 and LNK362-364 etc.
(6.3) Power supply of claim 1 realized dimming with LNK302/304˜306 shown in FIG. 27,28,29,31,32,33 in one implementation.
In real application, component can be more or less than FIG. 27,28,29,31,32,33 and component value maybe different from components in FIG. 27,28,29,31,32,33. Components connect way can be different from FIG. 27,28,29,31,32,33.
Dimming Feedback type1 use voltage divider with potentiometer.
Dimming Feedback type2 use voltage divider with potentiometer and zener diode or voltage reference.
For isolated converter, optocoupler, signal transformer, digital isolator can be used with type1 and type2 circuit.
The current goes into FB pin is proportional to output voltage. Regulation is maintained by skipping switching cycles. As the output voltage rises, the current into the FB pin will rise. If this exceeds Ifb (means output voltage is larger than predetermined voltage value) then subsequent cycles will be skipped until the current reduces below Ifb. Vice versa.
Thus, as the output load is reduced, more cycles will be skipped and if the load increases, fewer cycles are skipped.
So we adjust voltage divider value to adjust current into FB pin to regulate output voltage at predetermined value.
(6.4) The power supply of claim realizes dimming with LNK362-364 shown in FIG. 25 in one implementation.
In real application, component can be more or less than FIG. 25 and component value maybe different than components in FIG. 25. Components connect way can be different from FIG. 25.
Dimming Feedback type1 use voltage divider with potentiometer.
Dimming Feedback type2 use voltage divider with potentiometer and zener diode or voltage reference.
For isolated converter, opto-coupler, signal transformer, digital isolator can be used with type1 and type2 circuit.
When the output voltage is larger than predetermined value, current fed into the FEEDBACK pin of U1 (controller) increases until the turnoff threshold current is reached, disabling further switching cycles of U1, the output voltage is decreased until output voltage decreases to predetermined value. Vice versa.
So we adjust voltage divider value to adjust current into FB pin to regulate output voltage at predetermined value to realize dimming.

7. In the power supply of claim 1, in one implementation. Active startup circuit is used to start up the circuit when using IW2202 as controller. Active startup circuit can be integrated into IC controller.
In real application, component can be more or less than FIG. 20,21,22 and component value maybe different than components in FIG. 20,21,22. Active startup circuit is integrated in controller in other implementation. FIG. 20,21,22 has similar function. So we discuss with FIG. 20. FIG. 20 shows an active startup circuit. ASU pin is designed to drive the Mosfet of the active startup circuit. An external zener Z1 diode is to clamp the ASU pin. Before startup, ASU is floating. Once a voltage is supplied to Vg(t) (DC sinusoidal voltage after bridge rectifier like FIG. 9). The gate capacitor C31 starts to charge via the startup resistor R31. When Vcc reaches the threshold voltage of Q2, transistor Q2 conducts. (Q2 can be NPN transistor or N channel Mosfet). The startup capacitor C32 starts to be charged via the charge resistor R32 and R33 (R32 can be removed). When Vcc reaches the startup threshold voltage, controller (IW2202) starts operating. Converter main switch Q1 switches and auxiliary winding has voltage coupled from secondary output. ASU goes low, thus turns off Q2. Vcc is supplied from C32 that is charged by auxiliary winding and D4. Thus, supply voltage for PWM (IW2202) no longer uses linear regulator Q2 and the efficiency is improved. FIG. 23 Startup Timing Diagram on pins of IC controller shows that. By select auxiliary winding and secondary winding turns ratio carefully, we guarantee the voltage on the auxiliary winding during minimum dimming is larger than Vcc threshold+Voltage drop on D4; We guarantee the voltage on the auxiliary winding during normal operating is not high enough to damage R33 and Z2. Thus, we can guarantee PWM(IW2202) works well no matter in normal operation or dimming. Q2 can be a bipolar transistor; We can also connect a resistor between ASU pin and base of bipolar transistor. Some circuit may not need active startup circuit. Some circuits integrate active startup circuit in the controller.
Active startup circuit can also use topology as FIG. 20,21 or 22. Or even some circuit has more or less component as FIG. 20,21 or 22. Or component code or values may be different from FIG. 20,21,22. Or some components are integrated in IC. Active startup circuit may use components in different connection way from FIG. 20,21,22.
Active startup circuit can use other circuit different from FIG. 20,21 or 22; such as valley filled circuit, linear regulator or battery etc.

8. In the power supply of claim 1 has current limit protection.
In one implementation using IW2202 as controller 209, the primary peak current is limited by the Isense threshold voltage on a cycle-by-cycle basis. Isense pin is connected to the current sense resistor between ground and source of main switch Q1. At the moment the voltage level at Isense reaches the threshold, the main switch Q1 turns off, the minimum on-time is 180 ns. We can also use current sense transformer to replace current sense resistor. Secondary is rectified by a diode and connect to a resistor, then the voltage on the resistor is sent to Isense pin.
IW2210 also limits peak current cycle-by-cycle, it terminates the ON-time of the MOSFET if the current sense signal reaches its threshold.
LNK 302/304-306 and LNK362-364 have current limit circuit senses the current in the power MOSFET. When this current exceeds the internal threshold (Ilimit), the POWER MOSFET is turned off for the remainder of that cycle. The leading edge blanking circuit inhibits the current limit comparator for a short time (tleb) after the power MOSFET is turned on. This leading edge blanking time has been set so that current spikes caused by capacitance and rectifier reverse recovery time will not cause premature termination of the switching cycle.

9. The power supply of claim 1 has short circuit protection function in controller in one implementation (as LNK302/304-306 and LNK362-364 etc); The power supply of claim 1 has short circuit protection with Isense pin in one implementation as IW2202 and IW2210 etc, When short circuit happens, large current goes through main switch, Isense or controller interior circuit detect the large current and shuts down the main switch. In LNK302/304-306 or LNK362-364, when the current in Mosfet is larger than internal threshold, the power Mosfet is turned off for the remainder of that cycle.
For example, in IW2202, A short circuit condition on the DC supply output will cause a significant change of the output voltage. This change is detected typically within 10˜20 us by the Vsense signal. There are two conditions for output short-circuit detection as in IW2202.
(1) Vsense detects the rise of the DC supply output. If Vsense is less than 0.5V (typical) within 60 ms of the first OUTPUT pulse, the controller detects this as a short circuit condition and shuts down in a non-latched mode.
(2) After start-up, if the pulse width of Vsense is larger than 23 us for 2 consecutive cycles, the controller detects a short circuit condition and shuts down in a non-latched mode.

10. The power supply of claim 1 can have over voltage protection.
The signal of auxiliary winding passes diode D4 and a voltage divider then send to pin SD in IW2202 or OVP/OTP pin in IW2210.
If the voltage on SD or OVP/OTP pin exceeds the threshold voltage, the train of output pulses stops and the controller is latched off in one implementation or automatic restart in one implementation.
In one implementation with IW2210 as FIG. 15, OVP is realized by voltage divider R6,R7,R8 with auxiliary winding Na. When the output voltage is higher than threshold, the voltage coupled on the auxiliary winding is also higher than some value. Then the voltage sensed on OVP/OTP pin is higher than interior threshold. So the controller performs a latched shutdown operation which turns off the power supply. The operation resumes after cycling of the input line voltage.
LNK302/304-306 and LNK362-364 realize OVP with FB pin. Over voltage cause large current larger than threshold into FB pin. Then controller shuts down switch MOSFET. Thus output voltage will go down.

11. The power supply of claim 1 can have over temperature protection (OTP) function with SD pin in IW2202 or OVP/OTP pin in IW2210. OTP circuit is integrated in controller in LNK302/304-306 and LNK362-364 etc which senses the die temperature. A voltage divider composed of a thermistor and a resistor is connected to SD pin in IW2202 or OVP/OTP pin in IW2210. When the temperature goes high, thermistor value has catastrophe change, the voltage on the SD pin exceeds the threshold, the controller goes into a latched shutdown mode. Of course, a transistor or a Mosfet can be used with thermistor and resistor to realize same function.

12. The power supply of claim 1 can be parallel with the same power supply as claim 1 to minimize ripple. Output inductor is coupled or not coupled. Two controllers can be synchronized or not. Or even three or more power supplies of claim 1 are paralleled to minimize the ripple. (Input is connected together; Output is connected together.) Three or more controllers can be synchronized, not synchronized or multiphase control.

13. The secondary diode in power supply of claim 1 can be replaced by a Mosfet Q3 (Synchronized rectifier). When main switch Q1 is on, Q3 is off; When main switch Q1 is off, Q3 is on. The gate signal of Q3 can come from signal transformer, digital isolator IC, auxiliary winding or secondary winding or secondary IC controller etc

14. A filter in power supply of claim 1 can be connected between secondary diode and output lamp. The filter can be π filter, LC filter, differential mode filter, common mode filter or any kind of filter. The output filter can be a two winding transformer with opposite polarity winding. Top winding left is connected to secondary diode cathode; Top winding right is connected to output. Bottom winding left is connected to anther diode D5 cathode, bottom winding right is connected to output. The anode of D5 can connect to ground or another converter's secondary winding to minimize ripple.

15. In one implementation of power supply of claim 1, the main switch can be integrated in the controller as LNK302/304-306 or LNK362-364 in the power supply of claim 1. Other circuit or block can be integrated into IC controller such as active startup circuit 208.

16. In power supply of claim 1, the switching power supply can be installed in the metal lampstand. The insulation is applied between metal lampstand and switching power supply converter. Thus EMI will be shielded and be prevented from going outside.

17. The one stage AC to DC converter in power supply of claim 1 can be realized by flyback topology with IW2202 controller and IW2210;
The one stage AC to DC converter in power supply of claim 1 can be realized with LNK302/304-306 or LNK 362-364. Component code, value or connection way may be different from FIG. 12,13,14,15,16,17,24,25,27,28,29,31,32,33 etc.
The one stage converter 206 in power supply of claim 1 can use
Buck, Boost, Buck-boost, Noninverting buck-boost , H-Bridge, Watkins-Johnson, Current-fed bridge, Inverse of Watkins-Johnson, Cuk, SEPIC, Inverse of SEPIC, Buck square, full bridge, half bridge, Forward, Two-transistor Forward, Push-pull, Flyback, Push-pull converter based on Watkins-Johnson, Isolated SEPIC, Isolated Inverse SEPIC, Isolated Cuk, Two-transistor Flyback etc or any topology converter that convert DC sinusoidal voltage (FIG. 9) to DC constant voltage (FIG. 10).
Of course controller 209 may be different from IW2202, IW2210, iW1688, LNK302/304-306 or LNK362-364 for other topologies.
In real circuit, the component can be less or more than FIG. 11 to 53 etc. Components value and code can be different from FIG. 11 to 53 etc. Components connect way can be different from FIG. 11 to 53 etc.

18. The AC to DC converter is not used only for lamp. It is can also be used for any device requires DC power supply in all the industrial areas. (Telecommunication, Storage, Personal computer, cell phone power supply and charger, video game etc) For example, Bus AC to DC converter, PFC converter, PFC converter for lighting, Computer power supply, Monitor power supply, notebook adapter, LCD TV, AC/DC adapter, Battery charger, Power tool charger, Electronic ballast, Video game power supply, rotter power supply etc

19. The power supply of claim 1 can also be realized by two stage circuits, for example, PFC converter-first stage; DC/DC converter-second stage.

20. The power supply of claim 1 can also be used as charger with voltage adjustable.
